(19) United States
(12) Patent Application Publication
(10) Pub. No.: US 2019/0243758 A1
(43) Pub. Date: Aug. 8, 2019

(54) STORAGE CONTROL DEVICE AND STORAGE CONTROL METHOD

(71) Applicant: FUJITSU LIMITED, Kawasaki-shi (JP)

(72) Inventors: Kazuya Takeda, Kawasaki (JP); Yusuke Kurasawa, Nagano (JP); Yusuke Suzuki, Kawasaki (JP); Norihide KUBOTA, Kawasaki (JP); Yuji TANAKA, Inagi (JP); Toshio IGA, Kawasaki (JP); YOSHIHITO KONTA, Kawasaki (JP); Marino Kajiyama, Yokohama (JP); Takeshi WATANABE, Kawasaki (JP)

(73) Assignee: FUJITSU LIMITED, Kawasaki-shi (JP)

(21) Appl. No.: 16/243,124

(22) Filed: Jan. 9, 2019

(30) Foreign Application Priority Data
Feb. 2, 2018 (JP) 2018-017320

(51) Int. Cl. G06F 12/0804; G06F 12/02

(52) U.S. Cl. CPC G06F 12/0804; G06F 12/0253; G06F 2212/2022; G06F 2212/1036; G06F 2212/1044

(57) ABSTRACT

A storage control device includes a processor that reads out a group write area, in which data blocks are arranged, from a storage medium and store the group write area in a buffer area. The processor releases a part of the payload area for each data block arranged in the first group write area stored in the first buffer area. The part stores invalid data. The processor performs the garbage collection by performing data refilling. The data refilling is performed by moving valid data stored in the payload to fill up a front by using the released part, and updating an offset included in a header stored in a header area at a position indicated by index information corresponding to the moved valid data without changing the position indicated by the index information corresponding to the moved valid data. The header area is included in the data block.

### CROSS-REFERENCE TO RELATED APPLICATION

This application is based upon and claims the benefit of priority of the prior Japanese Patent Application No. 2018-017320, filed on Feb. 2, 2018, the entire contents of which are incorporated herein by reference.

### FIELD

The embodiments discussed herein are related to a storage control device and a storage control method.

### BACKGROUND

In recent years, the storage medium of a storage device has been shifted from an HDD (Hard Disk Drive) to a flash memory such as an SSD (Solid State Drive) having a relatively higher access speed. In the SSD, overwriting on a memory cell is not performed directly, but, for example, data writing is performed after data is erased in a unit of a 1 MB (megabyte) size block.

For this reason, when updating a portion of data in a block, it is necessary to save the other data in the block, erase the block, and then, write the saved data and the updated data. As a result, the processing for updating data that is smaller than the size of the block is slow. In addition, the SSD has an upper limit on the number of times of writing. Therefore, in the SSD, it is desirable to avoid updating data that is smaller than the size of the block as much as possible. Therefore, when updating a portion of data in the block, the other data in the block and the updated data is written in a new block.

In addition, there is a semiconductor storage device which prevents the access to a main memory by a CPU or a flash memory from being disturbed due to the concentration of execution of compaction search within a certain time. This semiconductor storage device includes a main memory for storing candidate information for determining a compaction candidate of a nonvolatile memory and a request issuing mechanism for issuing an access request for candidate information of the main memory. The semiconductor storage device further includes a delaying mechanism for delaying the access request issued by the request issuing mechanism for a predetermined time, and an accessing mechanism for accessing the candidate information of the main memory based on the access request delayed by the delaying mechanism.

In addition, there is a data storage device that may improve the efficiency of the compaction process by implementing a process of searching an effective compaction target block. The data storage device includes a flash memory with a block as a data erase unit, and a controller. The controller executes a compaction process on the flash memory, and dynamically sets a compaction process target range based on the number of usable blocks and the amount of valid data in the block. Further, the controller includes a compaction module for searching a block having a relatively small amount of valid data as a target block of the compaction process from the compaction process target range.

Related techniques are disclosed in, for example, Japanese Laid-open Patent Publication No. 2011-159069, Japanese Laid-open Patent Publication No. 2016-207195, and Japanese Laid-open Patent Publication No. 2013-030081.

### SUMMARY

According to an aspect of the present invention, provided is a storage control device for controlling a storage that employs a storage medium that has a limit in a number of times of writing. The storage control device includes a memory and a processor coupled to the memory. The memory is configured to provide a first buffer area for storing a group write area in which a plurality of data blocks are arranged. The group write area is a target of garbage collection to be performed by the storage control device. Each of the plurality of data blocks includes a header area and a payload area. The header area stores a header at a position indicated by index information corresponding to a data unit stored in the data block. The header includes an offset and a length of the data unit. The payload area stores the data unit at a position indicated by the offset. The processor is configured to read out a first group write area from the storage medium. The processor is configured to store the first group write area in the first buffer area. The processor is configured to release a part of the payload area for each data block arranged in the first group write area stored in the first buffer area. The part stores invalid data. The processor is configured to perform the garbage collection by performing data refilling. The data refilling is performed by moving valid data stored in the payload to fill up a front by using the released part, and updating an offset included in a header stored in the header area at a position indicated by index information corresponding to the moved valid data without changing the position indicated by the index information corresponding to the moved valid data.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating a storage configuration of a storage device according to an embodiment;

FIG. 2 is a view for explaining metadata used by a storage control device according to an embodiment;

FIG. 3 is a view for explaining a data block;

FIG. 4 is a view for explaining a data block map;

FIG. 5 is a view for explaining a physical area;

FIG. 6A is a view for explaining additional writing of a RAID unit;

FIG. 6B is an enlarged view of a data block in FIG. 6A;

FIG. 7 is a view for explaining group writing of the RAID unit;

FIG. 8A is a view illustrating a format of logical-physical meta;

FIG. 8B is a view illustrating a format of a data unit header;

FIG. 8C is a view illustrating a format of a data block header;

FIG. 9 is a view illustrating the configuration of an information processing system according to an embodiment;

FIG. 10A is a view illustrating an example of logical-physical meta, a data unit header, a RAID unit, and reference information before GC is performed;

FIG. 10B is a view illustrating a RAID unit and a data unit header after GC is performed;

FIG. 10C is a view illustrating additional writing after GC is performed;

FIG. 11 is a view for explaining GC cyclic processing;

FIG. 12 is a view illustrating an example of a relationship between a remaining capacity of a pool and a threshold value of an invalid data rate;

FIG. 13 is a view illustrating a relationship between functional parts with respect to GC;

FIG. 14 is a view illustrating a functional configuration of a GC unit;

FIG. 15 is a view illustrating a sequence of GC activation;

FIG. 16 is a view illustrating a sequence of GC cyclic monitoring;

FIG. 17 is a view illustrating a sequence of data refilling processing;

FIG. 18 is a flowchart illustrating a flow of data refilling processing;

FIG. 19 is a view illustrating a sequence of I/O reception control processing;

FIG. 20 is a view illustrating a sequence of forced WB processing;

FIG. 21 is a flowchart illustrating a flow of forced WB processing;

FIG. 22 is a view illustrating a sequence of delay control and multiplicity change processing;

FIG. 23 is a view illustrating an example of delay control and multiplicity change; and

FIG. 24 is a view illustrating a hardware configuration of a storage control device that executes a storage control program according to an embodiment.

### DESCRIPTION OF EMBODIMENTS

When updating a portion of data in the block, the SSD writes the other data and the updated data in the block in a new block, and, as a result, the block before the update is not used. Therefore, a garbage collection (GC: garbage collection) function is indispensable for a storage device using the SSD. However, unconditional execution of GC may cause a problem that the amount of data to be written increases and the lifetime of the SSD is shortened.

Hereinafter, embodiments of the present disclosure will be described in detail with reference to the accompanying drawings. The embodiments do not limit the disclosed technique.

### Embodiments

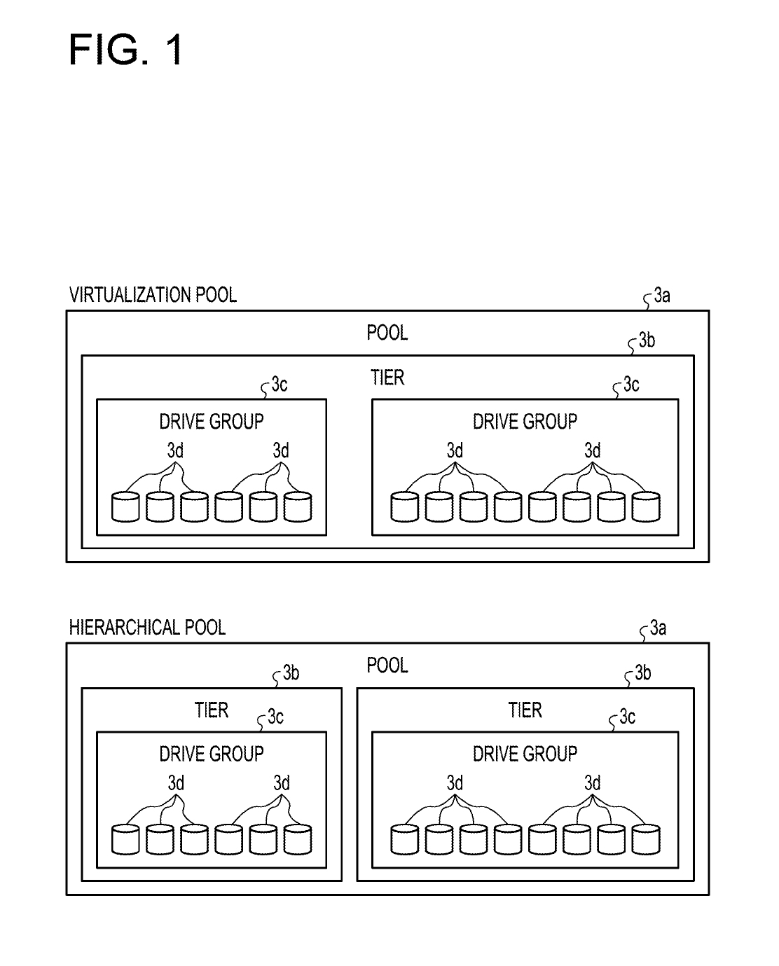

First, the storage configuration of a storage device according to an embodiment will be described. FIG. 1 is a view illustrating the storage configuration of a storage device according to an embodiment. As illustrated in FIG. 1, the storage device according to the embodiment uses plural SSDs 3d to manage a pool 3a based on RAID (Redundant Arrays of Inexpensive Disks) 6. Further, the storage device according to the embodiment has plural pools 3a.

The pool 3a includes a virtualization pool and a hierarchical pool. The virtualization pool has one tier 3b, and the hierarchical pool has two or more tiers 3b. The tier 3b has one or more drive groups 3c. Each drive group 3c is a group of SSDs 3d and has 6 to 24 SSDs 3d. For example, three of six SSDs 3d that store one stripe are used for storing user data (hereinafter, simply referred to as “data”), two are used for storing a parity, and one is used for a hot spare. Each drive group 3c may have 25 or more SSDs 3d.

Next, metadata used by a storage control device according to an embodiment will be described. Here, the metadata refers to data used by the storage control device to manage the data stored in the storage device.

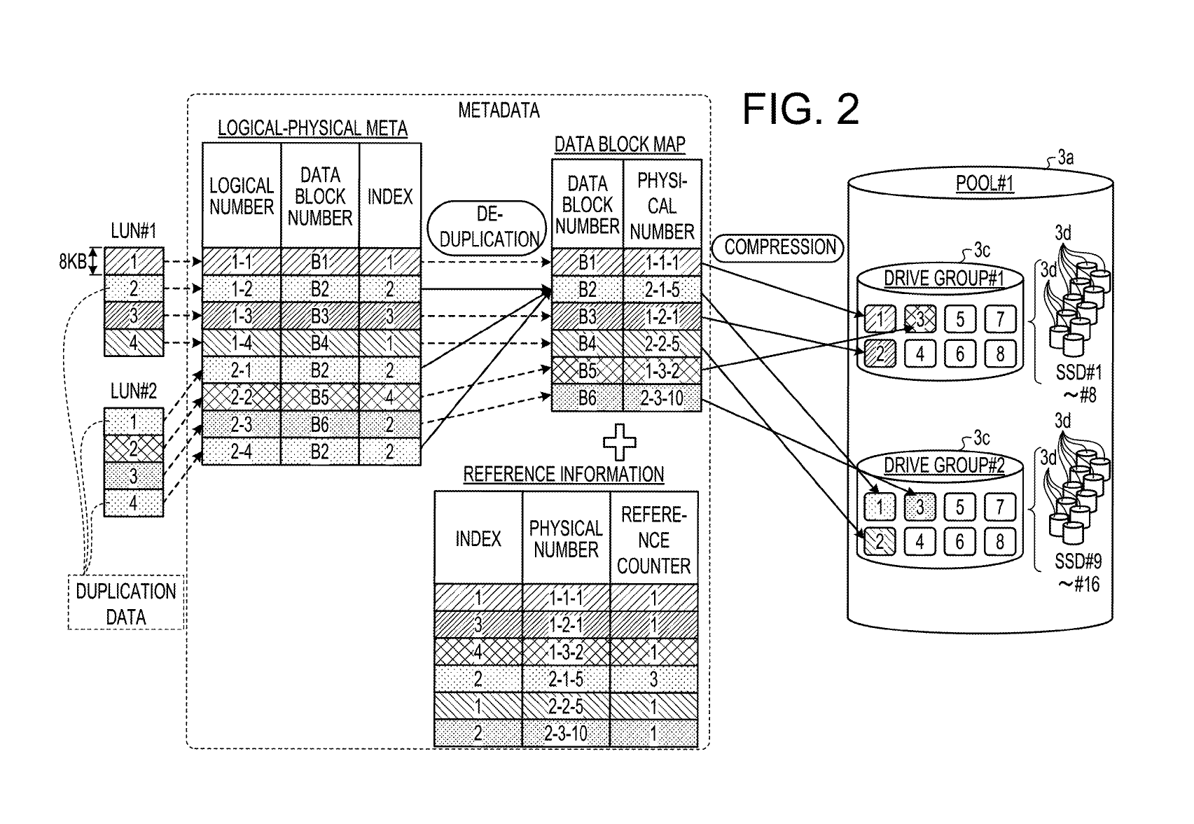

FIG. 2 is a view for explaining the metadata used by the storage control device according to the embodiment. As illustrated in FIG. 2, the metadata includes logical-physical meta, a data block map, and reference information.

The logical-physical meta is information for associating a logical number with a data block number (block ID) and an index. The logical number is a logical address used for identifying data by an information processing apparatus using the storage device, and is a combination of LUN (Logical Unit Number) and LBA (Logical Block Address). The size of the logical block is 8 KB (kilobytes), which is the unit size for de-duplication. In the present embodiment, since processing by a command from the information processing apparatus (host) to the storage device is performed in a unit of 512 bytes, data of 8 KB (8192 bytes) which is an integral multiple of 512 bytes is grouped to one logical block, for efficient de-duplication. The data block number is a number for identifying a data block that stores 8 KB data identified by a logical number. The index is a data number in the data block.

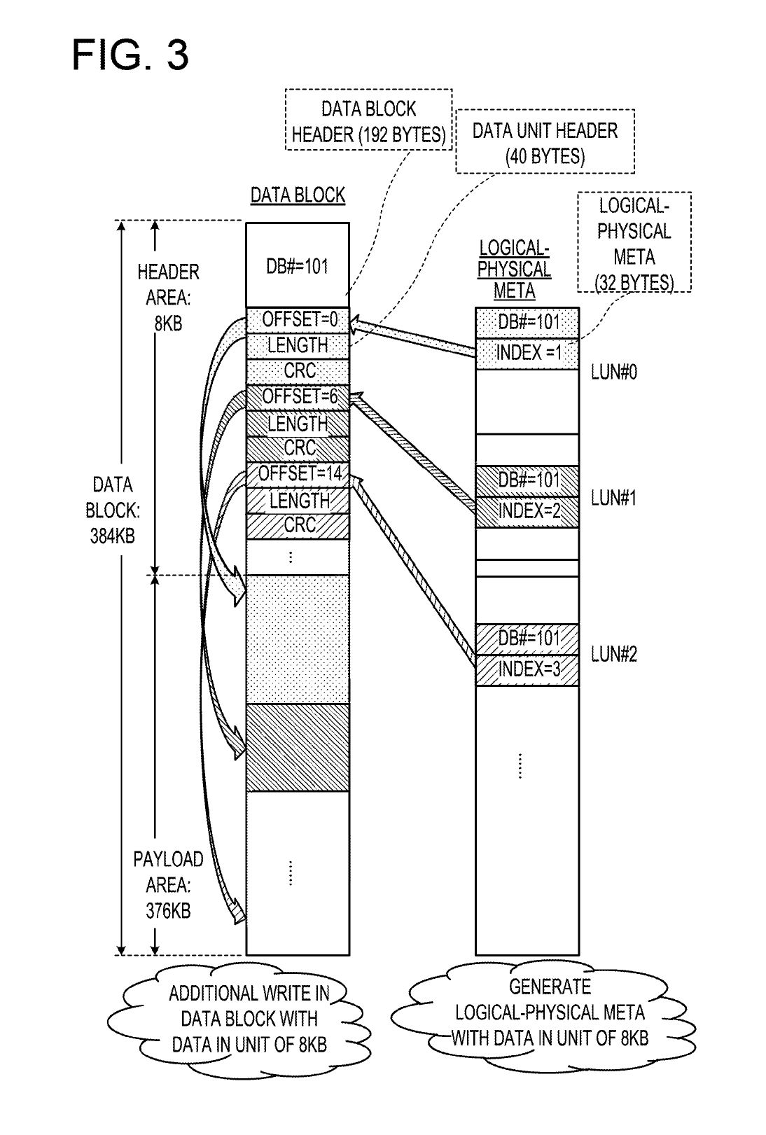

FIG. 3 is a view for explaining a data block. In FIG. 3, a data block number (DB#) is “101”. As illustrated in FIG. 3, the size of the data block is 384 KB. The data block has a header area of 8 KB and a payload area of 376 KB. The payload area has a data unit which is an area for storing compressed data. The data unit is additionally written in the payload area.

The header area includes a data block header of 192 bytes and up to 200 data unit headers of 40 bytes. The data block header is an area for storing information on the data block. The data block header includes information as to whether or not the data unit may be additionally written, the number of data units which are additionally written, and information on a position where the data unit is to be additionally written next.

Each data unit header corresponds to a data unit included in the payload area. The data unit header is at a position corresponding to the index of data stored in the corresponding data unit. The data unit header includes an offset, a length, and a CRC (Cyclic Redundancy Check). The offset indicates a writing start position (head position) within the data block of the corresponding data unit. The length indicates the length of the corresponding data unit. The CRC is an error detection code before compression of the corresponding data unit.

In the logical-physical meta of FIG. 2, for example, data whose logical number is “1-1” is stored in the first data block whose data block number is “B1”. Here, “1-1” indicates that the LUN is 1 and the LBA is 1. For the same data, due to de-duplication, the data block number and the index are the same. In FIG. 2, since data identified by “1-2”, “2-1”, and “2-4” are the same, “1-2”, “2-1”, and “2-4” are associated with a data block number “B2” and an index “2”.

The data block map is a table for associating a data block number and a physical number with each other. The physical number is a combination of a DG number (DG#) for identifying a drive group (DG) 3c, an RU number (RU#) for identifying a RAID unit (RU), and a slot number (slot#) for identifying a slot. The RAID unit is a group write area buffered on a main memory when data is written in the storage device, in which plural data blocks may be arranged. The data is additionally written for each RAID unit in the storage device. The size of the RAID unit is, for example, 24 MB (megabytes). In the RAID unit, each data block is managed using slots.

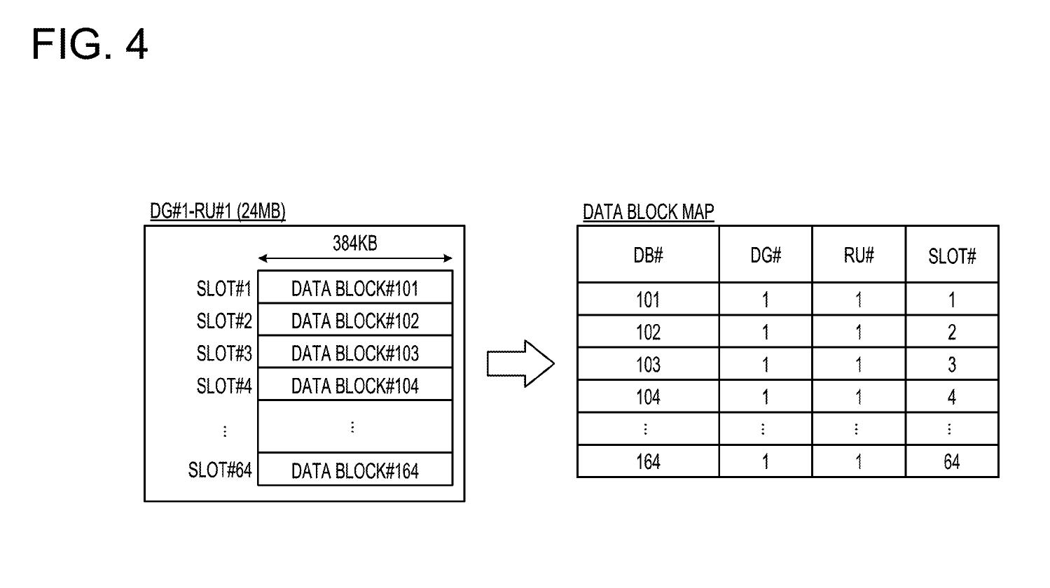

FIG. 4 is a view for explaining a data block map. FIG. 4 illustrates a data block map related to a RAID unit whose DG number is “1” (DG#1) and whose RU number is “1” (RU#1). As illustrated in FIG. 4, since the size of the RAID unit is 24 MB and the size of the data block is 384 KB, the number of slots is 64.

FIG. 4 illustrates an example where data blocks are allocated to the respective slots in an ascending order of addresses of the data blocks, in which a data block#101 is stored in a slot#1, a data block#102 is stored in a slot#2, . . . , a data block#164 is stored in a slot#64.

In the data block map of FIG. 2, for example, a data block number “B1” is associated with a physical number “1-1-1”. The data of the data block number “B1” is compressed and stored in a slot#1 of the RAID unit with the RU number “1” of the drive group#1 of the pool 3a. In the pool 3a of FIG. 2, the tier 3b and its slot are omitted.

The reference information is information for associating an index, a physical number, and a reference counter with each other. The reference counter is the number of duplications of data identified by the index and the physical number. In FIG. 2, the index may be included in the physical number.

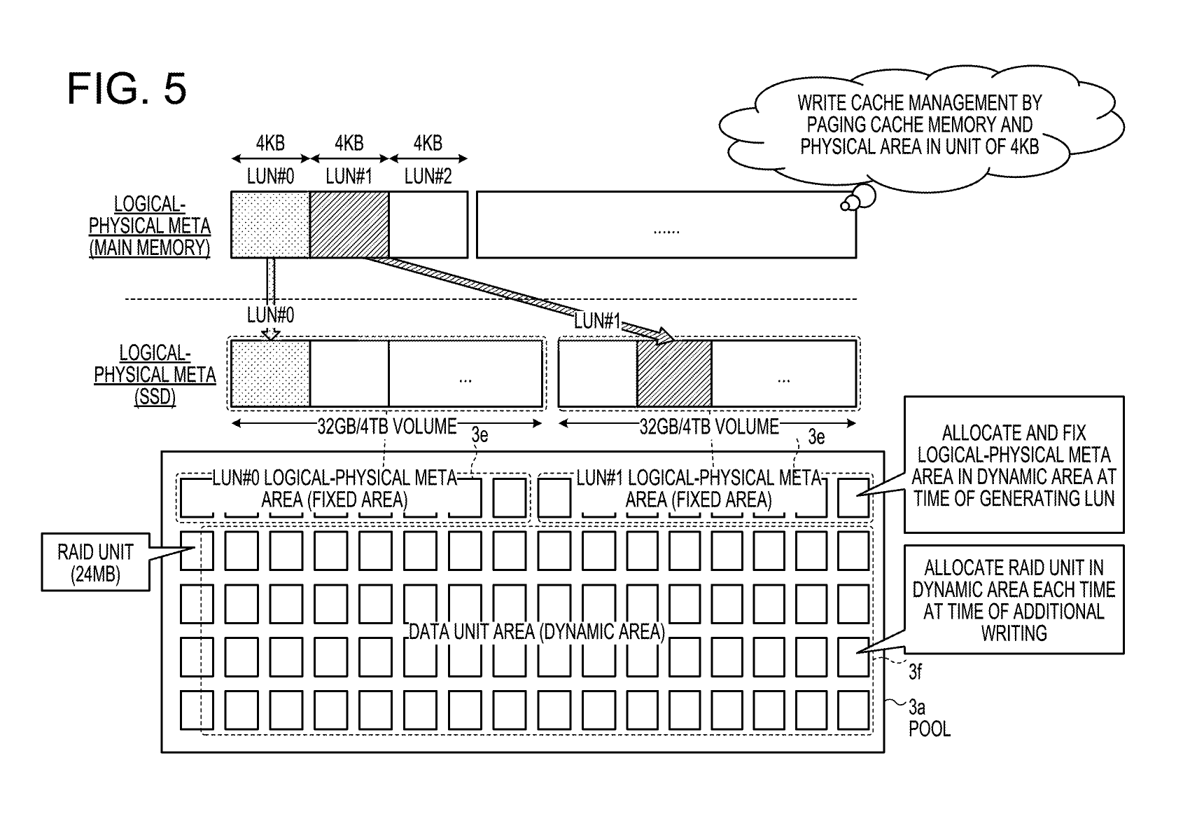

FIG. 5 is a view for explaining a physical area. As illustrated in FIG. 5, the logical-physical meta is stored in both the main memory and the storage. Only a part of the logical-physical meta is stored in the main memory. Only one page (4 KB) of the logical-physical meta is stored in the main memory for each LUN. When a page corresponding to a combination of LUN and LBA is not present on the main memory, the page of the LUN is paged out and the page corresponding to the combination of LUN and LBA is read from the storage into the main memory.

A logical-physical meta area 3e (area where the logical-physical meta is stored) of 32 GB is stored in the storage for each volume of 4 TB (terabytes). The logical-physical meta area 3e is allocated from a dynamic area and becomes a fixed area at the time when the LUN is generated. Here, the dynamic area refers to an area dynamically allocated from the pool 3a. The logical-physical meta area 3e is not the target of GC. The RAID unit is allocated from the dynamic area when data is additionally written in the storage. In reality, the RAID unit is allocated when data is additionally written in a write buffer in which the data is temporarily stored before being stored in the storage. A data unit area 3f in which the RAID unit is stored is the target of GC.

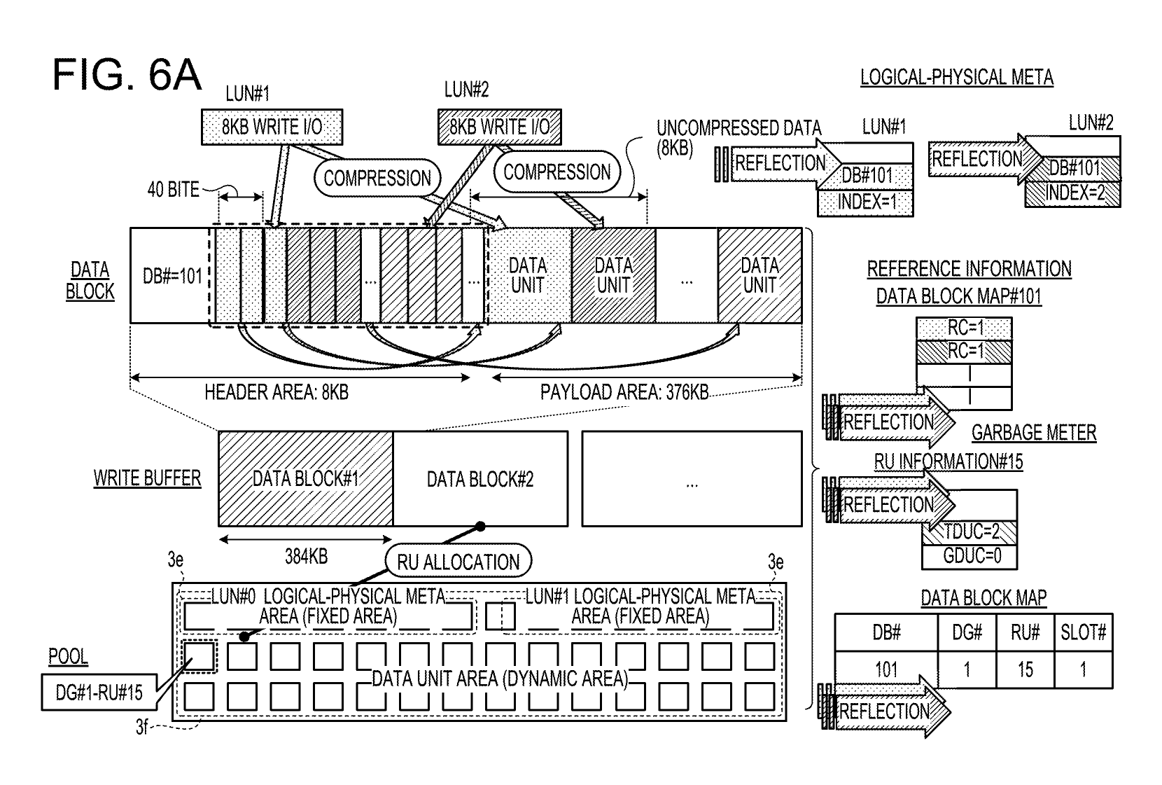

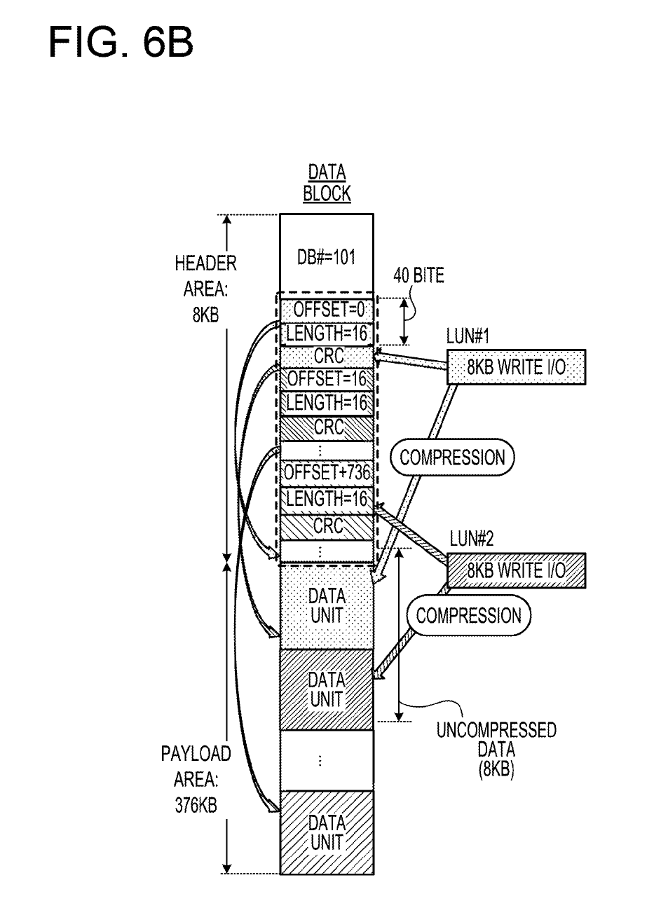

FIGS. 6A and 6B are views for explaining additional writing of the RAID unit. As illustrated in FIGS. 6A and 6B, when a write I/O of 8 KB (command to write data in the storage) is received in a LUN#1, a data unit header is written in the header area of a data block on the write buffer, the data is compressed and written in the payload area, and the data block header is updated. Thereafter, when the write I/O of 8 KB is received in a LUN#2, in the example of FIGS. 6A and 6B, the data unit header is additionally written in the header area of the same data block, the data is compressed and additionally written in the payload area, and the data block header is updated.

Then, in a storage area corresponding to the capacity of the data block secured in the write buffer, when the header area or the payload area in the data block becomes full (when an available free area disappears), no data is additionally written in the data block thereafter. Then, when all the data blocks of the RAID unit in the write buffer become full (when an available free area disappears), the contents of the write buffer are written in the storage. Thereafter, the storage area of the write buffer allocated to the RAID unit is released. In FIGS. 6A and 6B, the RAID unit of DG#1 and RU#15 is allocated from the dynamic area.

In addition, the write I/O in the LUN#1 is reflected in an area corresponding to the LUN#1 of the logical-physical meta, and the write I/O in the LUN#2 is reflected in an area corresponding to the LUN#2 of the logical-physical meta. In addition, the reference count on the data of the write I/O is updated, and the write I/O is reflected in the reference information.

In addition, TDUC (Total Data Unit Count) and GDUC (GC Data Unit Count) included in RU information#15 which is information on the RU#15 are updated, and the write I/O is reflected in a garbage meter. Here, the garbage meter is GC-related information included in the RU information. The TDUC is the total number of data units in the RU and is updated at the time of writing of the data unit. The GDUC is the number of invalid data units in the RU and is updated at the time of updating of the reference counter.

In addition, in the data block map, the DG#1, the RU#15, and the slot#1 are associated with a DB#101, and the write I/O is reflected in the data block map.

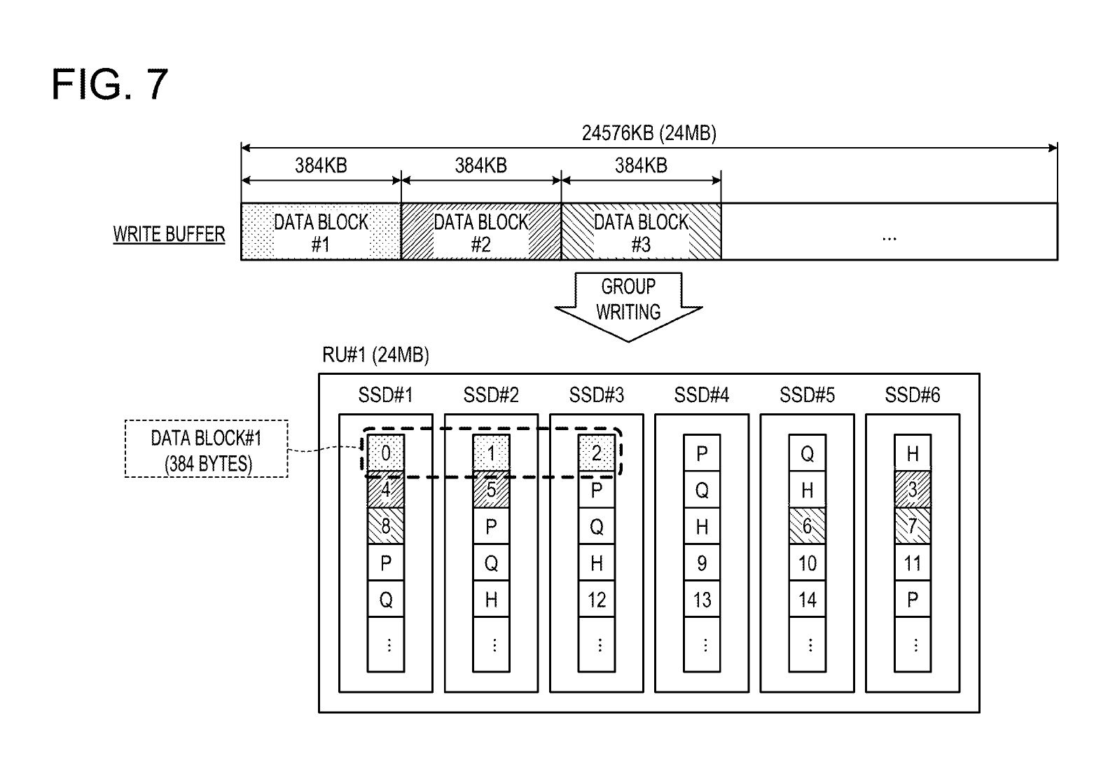

FIG. 7 is a view for explaining group writing of the RAID unit. As illustrated in FIG. 7, the data blocks are buffered in the write buffer, grouped in the unit of the RAID unit, and written in the storage. For example, a data block#1 is written in six SSDs 3d that store one stripe. In FIG. 7, P and Q are parities and H is a hot spare. The data block#1 is written in areas of “0”, “1”, . . . , “14” in FIG. 7 every 128 bytes.

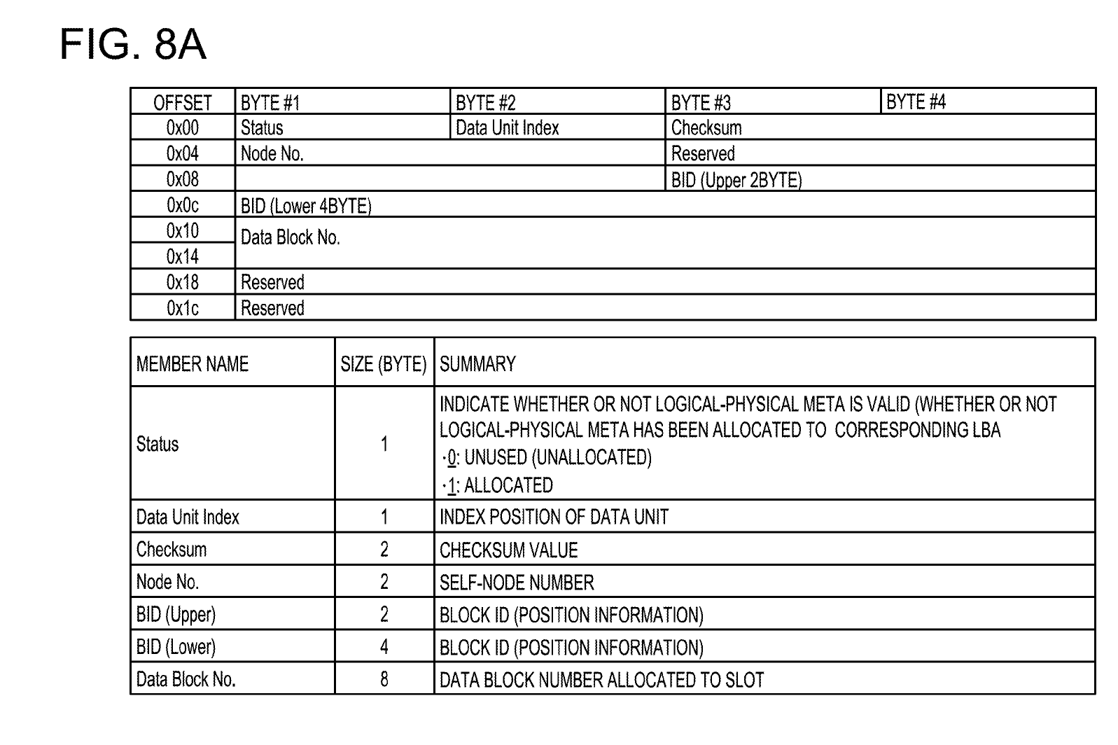

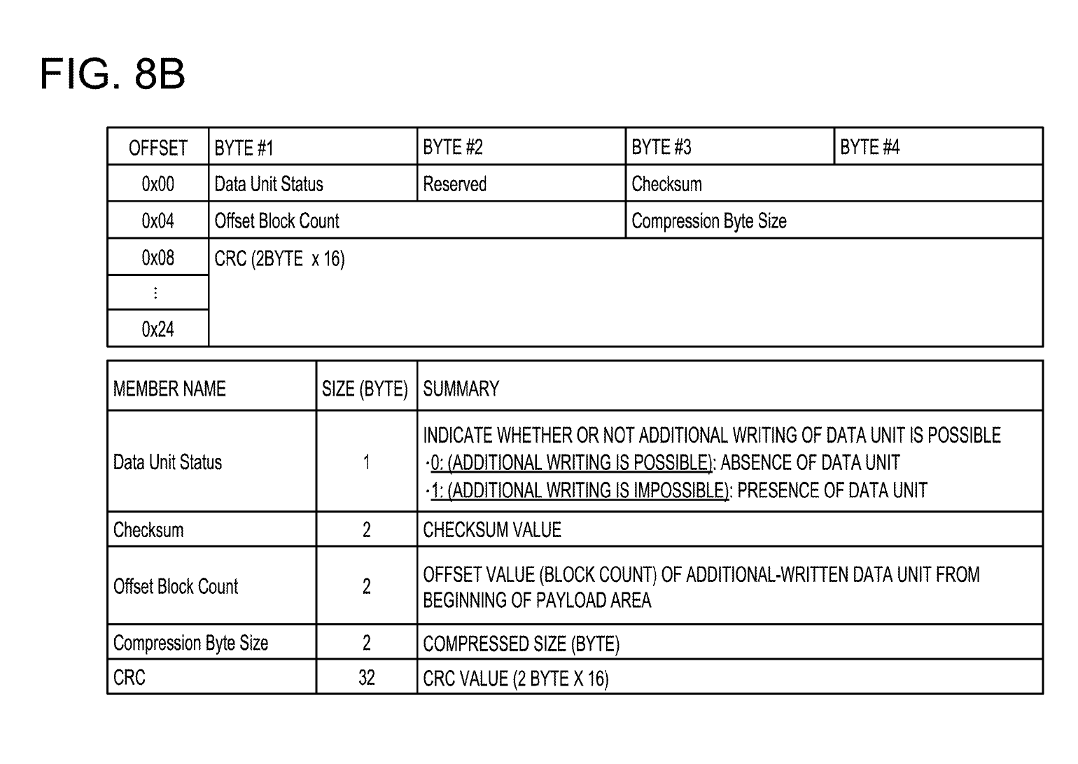

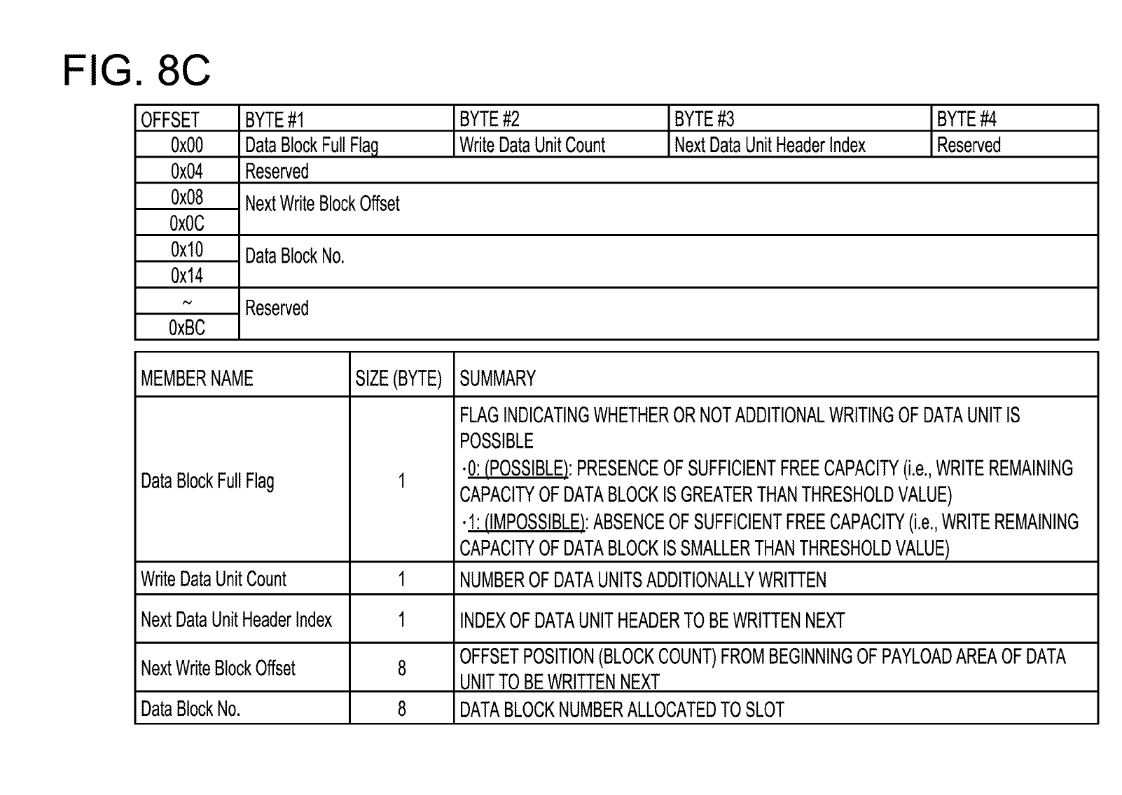

FIG. 8A is a view illustrating the format of logical-physical meta. As illustrated in FIG. 8A, the logical-physical meta of 32 bytes includes Status of 1 byte, Data Unit Index of 1 byte, Checksum of 2 bytes, Node No. of 2 bytes, and BID of 6 bytes. The logical-physical meta of 32 bytes further includes Data Block No. of 8 bytes.

The Status indicates the valid/invalid status of the logical-physical meta. The valid status refers to the status where the logical-physical meta has already been allocated to the corresponding LBA, and the invalid status refers to the status where the logical-physical meta has not yet been allocated to the corresponding LBA. The Data Unit Index is an index. The Checksum is an error code detection value of corresponding data. The Node No. is a number for identifying a storage device (node). The BID is a block ID (position information), that is, an LBA. The Data Block No. is a data block number. The Reserved indicates that all bits are 0 for future expansion.

FIG. 8B is a view illustrating the format of a data unit header. As illustrated in FIG. 8B, the data unit header of 40 bytes includes Data Unit Status of 1 byte, Checksum of 2 bytes, and Offset Block Count of 2 bytes. The data unit header of 40 bytes further includes Compression Byte Size of 2 bytes and CRC of 32 bytes.

The Data Unit Status indicates whether or not a data unit may be additionally written. When there is no data unit corresponding to the data unit header, a data unit may be additionally written. When there is a data unit corresponding to the data unit header, a data unit is not additionally written. The Checksum is an error code detection value of the corresponding data unit.

The Offset Block Count is an offset from the beginning of the payload area of the corresponding data unit. The Offset Block Count is represented by the number of blocks. However, the block here is a block of 512 bytes, not a block of the erase unit of SSD. In the following, in order to distinguish a block of 512 bytes from a block of the erase unit of SSD, the block of 512 bytes will be referred to as a small block. The Compression Byte Size is the compressed size of the corresponding data. The CRC is an error detection code of the corresponding data unit.

FIG. 8C is a view illustrating the format of a data block header. As illustrated in FIG. 8C, the data block header of 192 bytes includes Data Block Full Flag of 1 byte and Write Data Unit Count of 1 byte. The data block header of 192 bytes further includes Next Data Unit Header Index of 1 byte, Next Write Block Offset of 8 bytes, and Data Block No. of 8 bytes.

The Data Block Full Flag is a flag that indicates whether or not a data unit may be additionally written. When the write remaining capacity of the data block is equal to or greater than a threshold value and there is a free capacity sufficient for additional writing of a data unit, a data unit may be additionally written. Meanwhile, when the write remaining capacity of the data block is less than the threshold value and there is no free capacity sufficient for additional writing of a data unit, a data unit is not additionally written.

The Write Data Unit Count is the number of data units additionally written in the data block. The Next Data Unit Header Index is an index of a data unit header to be written next. The Next Write Block Offset is an offset position from the beginning of the payload area of the data unit to be written next. The unit thereof is the number of small blocks. The Data Block No. is a data block number allocated to a slot.

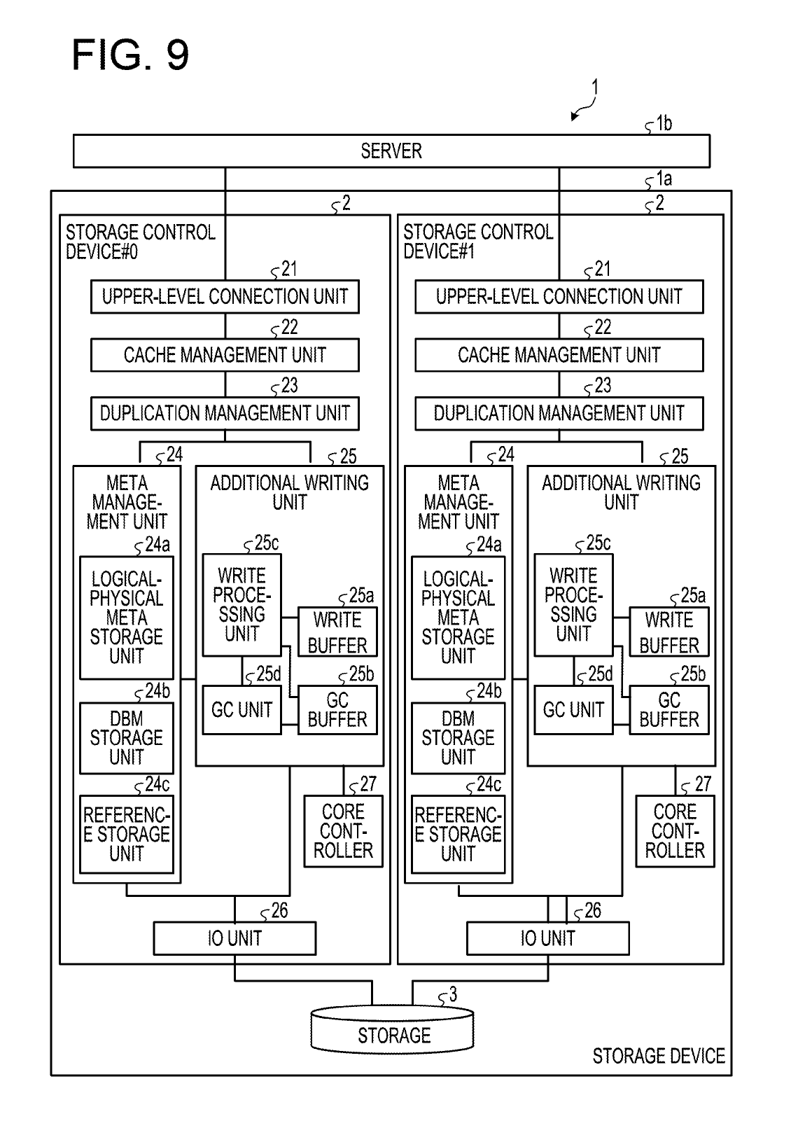

Next, the configuration of an information processing system according to an embodiment will be described. FIG. 9 is a view illustrating the configuration of the information processing system according to the embodiment. As illustrated in FIG. 9, the information processing system 1 according to the embodiment includes a storage device 1a and a server 1b. The storage device 1a is a device that stores data used by the server 1b. The server 1b is an information processing apparatus that performs a task such as information processing. The storage device 1a and the server 1b are coupled to each other by FC (Fiber Channel) and iSCSI (Internet Small Computer System Interface).

The storage device 1a includes a storage control device 2 that controls the storage device 1a and a storage (memory) 3 that stores data. Here, the storage 3 is a group of plural SSDs 3d.

In FIG. 9, the storage device 1a includes two storage control devices 2 represented by a storage control device#0 and a storage control device#1. However, the storage device 1a may include three or more storage control devices 2. Further, in FIG. 9, the information processing system 1 includes one server 1b. However, the information processing system 1 may include two or more servers 1b.

The storage control devices 2 share and manage the storage 3 and are in charge of one or more pools 3a. Each storage control device 2 includes an upper-level connection unit 21, a cache management unit 22, a duplication management unit 23, a meta management unit 24, an additional writing unit 25, an IO unit 26, and a core controller 27.

The upper-level connection unit 21 exchanges information between a FC driver/iSCSI driver and the cache management unit 22. The cache management unit 22 manages data on a cache memory. The duplication management unit 23 manages unique data stored in the storage device 1a by controlling data de-duplication/restoration.

The meta management unit 24 manages the logical-physical meta, the data block map, and the reference count. In addition, the meta management unit 24 uses the logical-physical meta and the data block map to perform conversion of a logical address used for identifying data in a virtual volume and a physical address indicating a position in the SSD 3d at which the data is stored. Here, the physical address is a set of a data block number and an index.

The meta management unit 24 includes a logical-physical meta storage unit 24a, a DBM storage unit 24b, and a reference storage unit 24c. The logical-physical meta storage unit 24a stores the logical-physical meta. The DBM storage unit 24b stores the data block map. The reference storage unit 24c stores the reference information.

The additional writing unit 25 manages data as continuous data units, and performs additional writing or group writing of the data in the SSD 3d for each RAID unit. Further, the additional writing unit 25 compresses and decompresses the data. The additional writing unit 25 stores write data in the buffer on the main memory, and determines whether or not a free area of the write buffer has become equal to or less than a specific threshold value every time the write data is written in the write buffer. Then, when the free area of the write buffer has become equal to or less than the specific threshold value, the additional writing unit 25 begins to writes the write buffer in the SSD 3d. The additional writing unit 25 manages a physical space of the pool 3a and arranges the RAID units.

The upper-level connection unit 21 controls data de-duplication/restoration, and the additional writing unit 25 compresses and decompresses the data, so that the storage control device 2 may reduce write data and further reduce the number of times of write.

The IO unit 26 writes the RAID unit in the storage 3. The core controller 27 controls threads and cores.

The additional writing unit 25 includes a write buffer 25a, a GC buffer 25b, a write processing unit 25c, and a GC unit 25d. While FIG. 9 illustrates one GC buffer 25b, the additional writing unit 25 has plural GC buffers 25b.

The write buffer 25a is a buffer in which the write data is stored in the format of the RAID unit on the main memory. The GC buffer 25b is a buffer on the main memory that stores the RAID unit which is the target of GC.

The write processing unit 25c uses the write buffer 25a to perform data write processing. As described later, when the GC buffer 25b is set to be in an I/O receivable state, the write processing unit 25c preferentially uses the set GC buffer 25b to perform the data write processing.

The GC unit 25d performs GC for each pool 3a. The GC unit 25d reads the RAID unit from the data unit area 3f into the GC buffer 25b, and uses the GC buffer 25b to perform GC when an invalid data rate is equal to or greater than a predetermined threshold value.

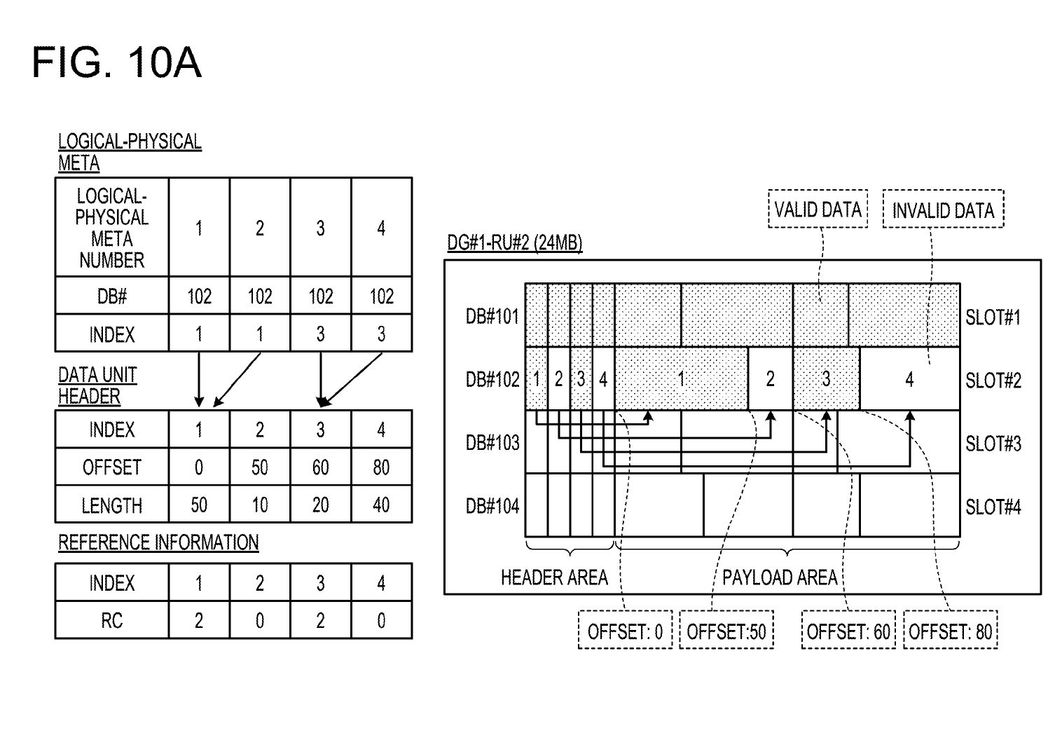

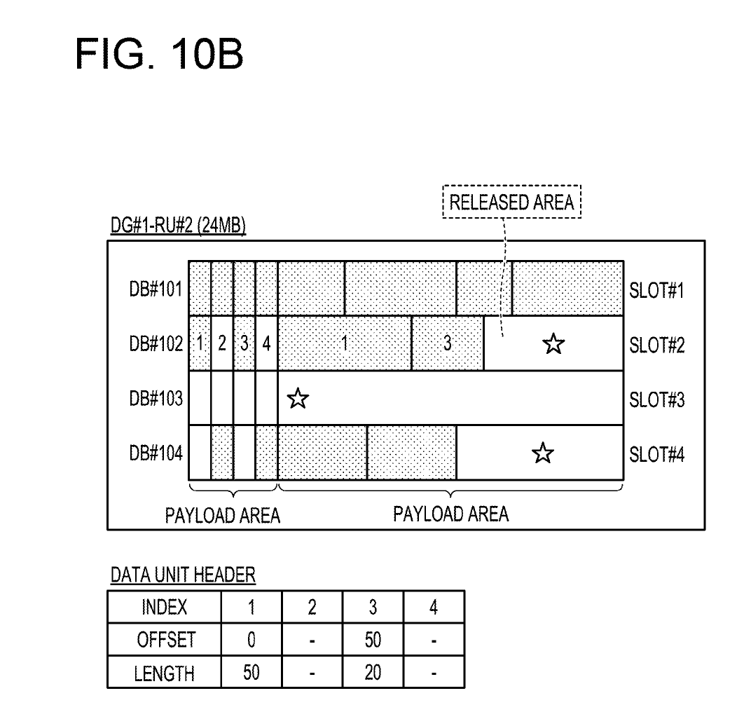

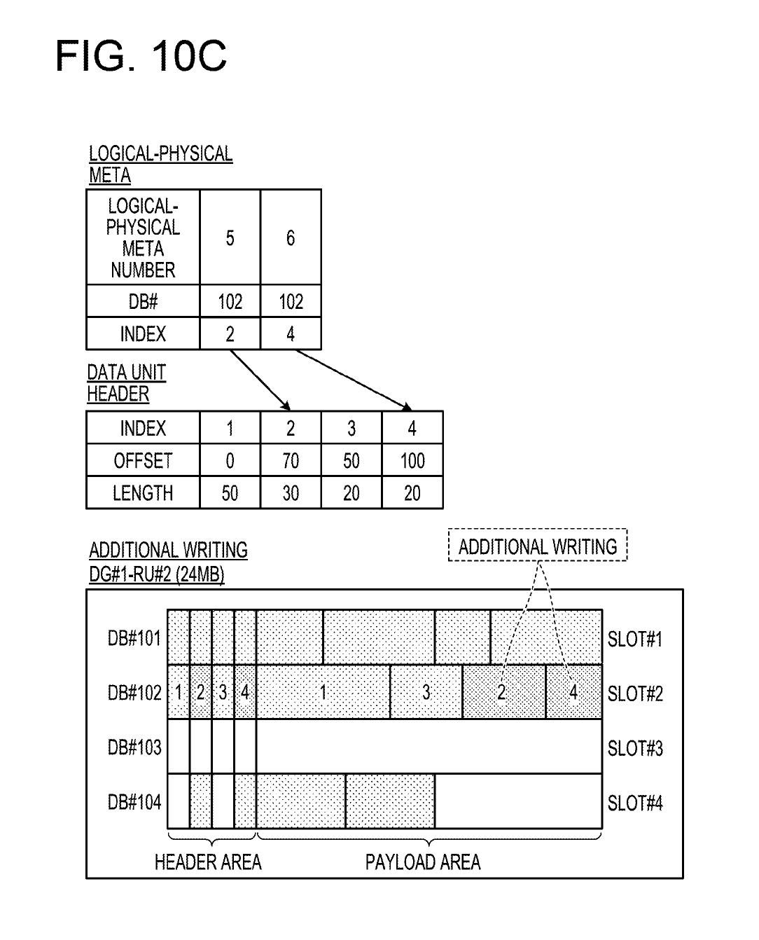

Examples of GC by the GC unit 25d are illustrated in FIGS. 10A to 10C. FIG. 10A is a view illustrating an example of logical-physical meta, a data unit header, a RAID unit, and reference information before GC is performed, FIG. 10B is a view illustrating a RAID unit and a data unit header after GC is performed, and FIG. 10C is a view illustrating additional writing after GC is performed. FIGS. 10A to 10C omit the CRC of the data unit header and the DB# of the reference information.

As illustrated in FIG. 10A, before GC, data units with indexes “1” and “3” of DB#102 are registered in the logical-physical meta, and are associated with two LUNs/LBAs, respectively. Data units with indexes “2” and “4” of DB#102 are not associated with any LUN/LBA. Therefore, RC (reference counter) of the data units with indexes “1” and “3” of DB#102 is “2”, and RC of the data units with indexes “2” and “4” of DB#102 is “0”. The data units with indexes “2” and “4” of DB#102 are the target of GC.

As illustrated in FIG. 10B, after GC is performed, the data unit with index “3” of DB#102 is moved to fill up the front in the data block (this operation is referred to as front-filling). Then, the data unit header is updated. Specifically, an offset of index “3” of DB#102 is updated to “50”. In addition, the data unit header corresponding to the indexes “2” and “4” is updated to unused (-). Further, the logical-physical meta and the reference information are not updated.

As illustrated in FIG. 10C, new data having compressed lengths of “30” and “20” are additionally written at positions indicated by the indexes “2” and “4” of the DB#102, and the indexes “2” and “4” of the data unit header are updated. The offset of the index “2” of the data unit header is updated to “70”, and the length thereof is updated to “30”. The offset of the index “4” of the data unit header is updated to “100”, and the length thereof is updated to “20”. That is, the indexes “2” and “4” of DB#102 are reused. In addition, the RCs corresponding to the indexes “2” and “4” are updated.

In this manner, the GC unit 25d performs front-filling of data units in the payload area. The payload area released by the front-filling is reused so as to use the released payload area with high efficiency. Therefore, GC by the GC unit 25d has high volumetric efficiency. Further, the GC unit 25d does not perform front-filling on the data unit header.

In addition, the GC unit 25d does not perform refilling of the slot. Even when the entire slot is free, the GC unit 25d does not perform front-filling of the next slot. Therefore, the GC unit 25d is not required to update the data block map. Further, the GC unit 25d does not perform refilling of data between the RAID units. When the RAID unit has a free space, the GC unit 25d does not perform front-filling of data from the next RAID unit. Therefore, the GC unit 25d is not required to update the data block map and the reference information.

In this manner, the GC unit 25d is not required to update the logical-physical meta, the data block map, and the reference information in the

GC processing, thereby reducing write of data into the storage 3. Therefore, the GC unit 25d may improve the processing speed.

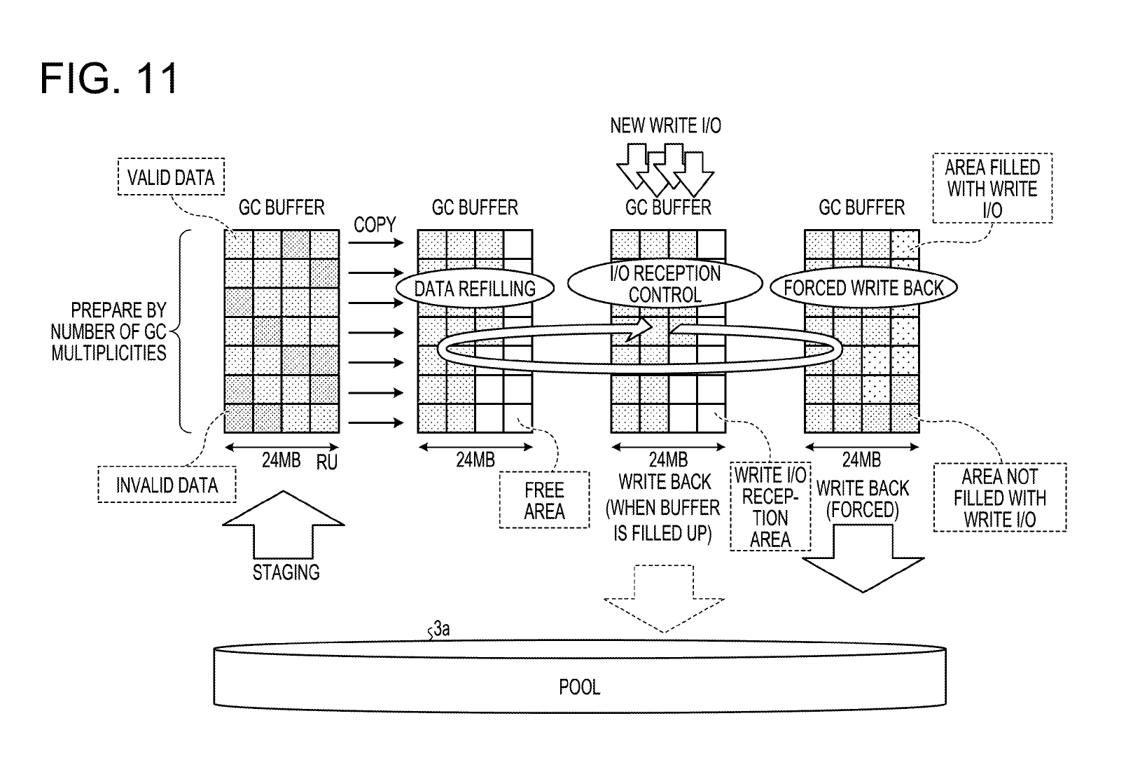

FIG. 11 is a view for explaining GC cyclic processing. Here, the GC cyclic processing refers to a processing performed in the order of data refilling, I/O reception control, and forced write back. In FIG. 11, staging refers to reading a RAID unit into the GC buffer 25b.

The data refilling includes the front-filling and the update of the data unit header illustrated in FIG. 10B. Although an image of front-filling in the RAID unit is illustrated in FIG. 11 for convenience of explanation, the front-filling is performed only within the data block.

The I/O reception control is the additional writing illustrated as an example in FIG. 10C. When the contents of the GC buffer 25b are written in the storage 3 after the data refilling, there is a free area in the data block, which results in low storage efficiency. Therefore, the GC unit 25d receives I/O (writing data in the storage device 1a and reading data from the storage device 1a), and fills the free area with the received I/O.

The forced write back is to forcibly write back the GC buffer 25b in the pool 3a when the GC buffer 25b is not filled within a predetermined time. By performing the forced write back, even when the write I/O does not come, the GC unit 25d may advance the GC cyclic processing. In addition, the forced write-backed RAID unit becomes preferentially the GC target when the pool 3a including the forced written-back RAID unit is next subjected to GC.

The GC unit 25d operates the respective processes in parallel. In addition, the data refilling is performed with a constant multiplicity. In addition, the additional writing unit 25 performs the processing of the GC unit 25d with a CPU (Central Processing Unit) core, separately from the I/O processing.

When the remaining capacity of the pool 3a is sufficient, the GC unit 25d efficiently secures a free capacity. Meanwhile, when the remaining capacity of the pool 3a is small, the free area is all released. Therefore, the GC unit 25d changes the threshold value of the invalid data rate of the RAID unit as the GC target based on the remaining capacity of the pool 3a.

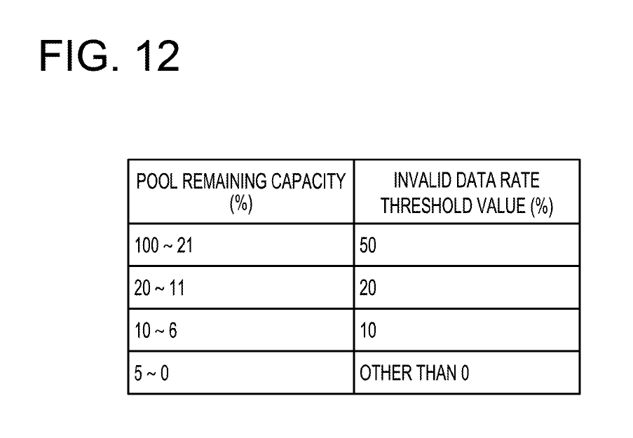

FIG. 12 is a view illustrating an example of the relationship between the remaining capacity of the pool 3a and the threshold value of the invalid data rate. As illustrated in FIG. 12, for example, when the remaining capacity of the pool 3a is 21% to 100%, the GC unit 25d takes the RAID unit having the invalid data rate of 50% or more as the GC target. When the remaining capacity of the pool 3a is 0% to 5%, the GC unit 25d takes the RAID unit with the invalid data rate other than 0% as the GC target. However, when the remaining capacity of the pool 3a is equal to or less than 5%, the GC unit 25d preferentially performs GC from the RAID unit having a relatively higher invalid data rate in order to efficiently increase the free capacity.

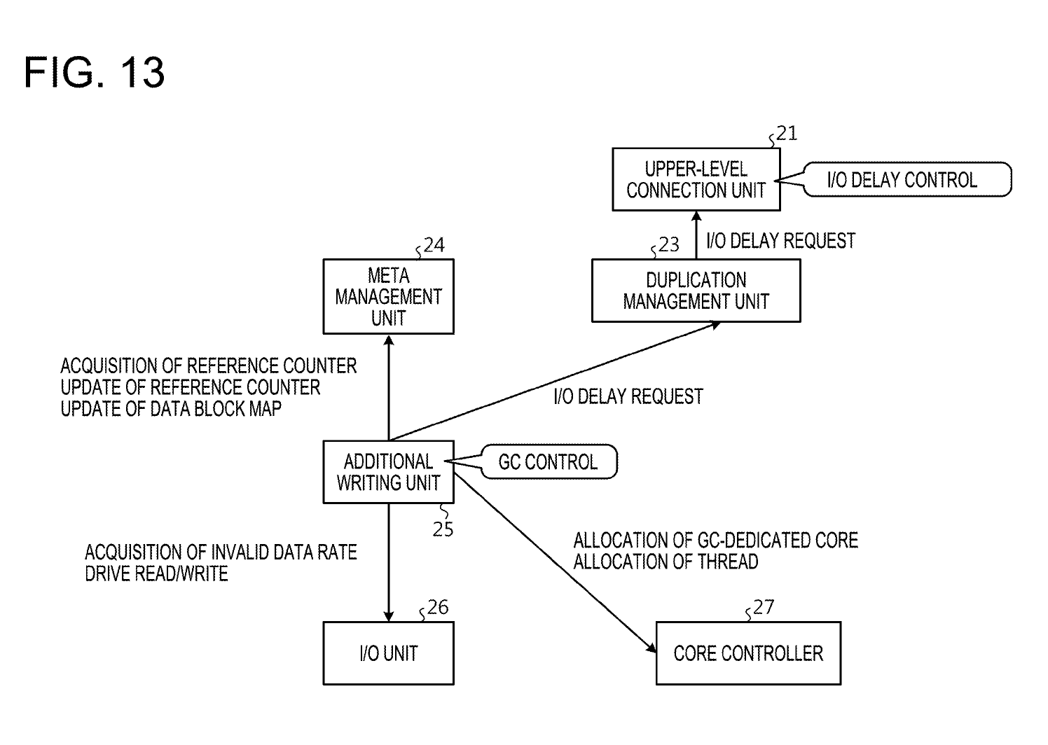

FIG. 13 is a view illustrating the relationship between functional parts with respect to GC. As illustrated in FIG. 13, the additional writing unit 25 performs control on the general GC. In addition, the additional writing unit 25 requests the meta management unit 24 to acquire the reference counter, update the reference counter, and update the data block map. In addition, the additional writing unit 25 requests the duplication management unit 23 for I/O delay. The duplication management unit 23 requests the upper-level connection unit 21 for I/O delay, and the upper-level connection unit 21 performs I/O delay control.

In addition, the additional writing unit 25 requests the IO unit 26 to acquire the invalid data rate and perform drive read/write. Here, the drive read indicates reading of data from the storage 3, and the drive write indicates writing of data in the storage 3. In addition, the additional writing unit 25 requests the core controller 27 to allocate a GC-dedicated core and a thread. The core controller 27 may raise the multiplicity of GC by increasing the allocation of GC thread.

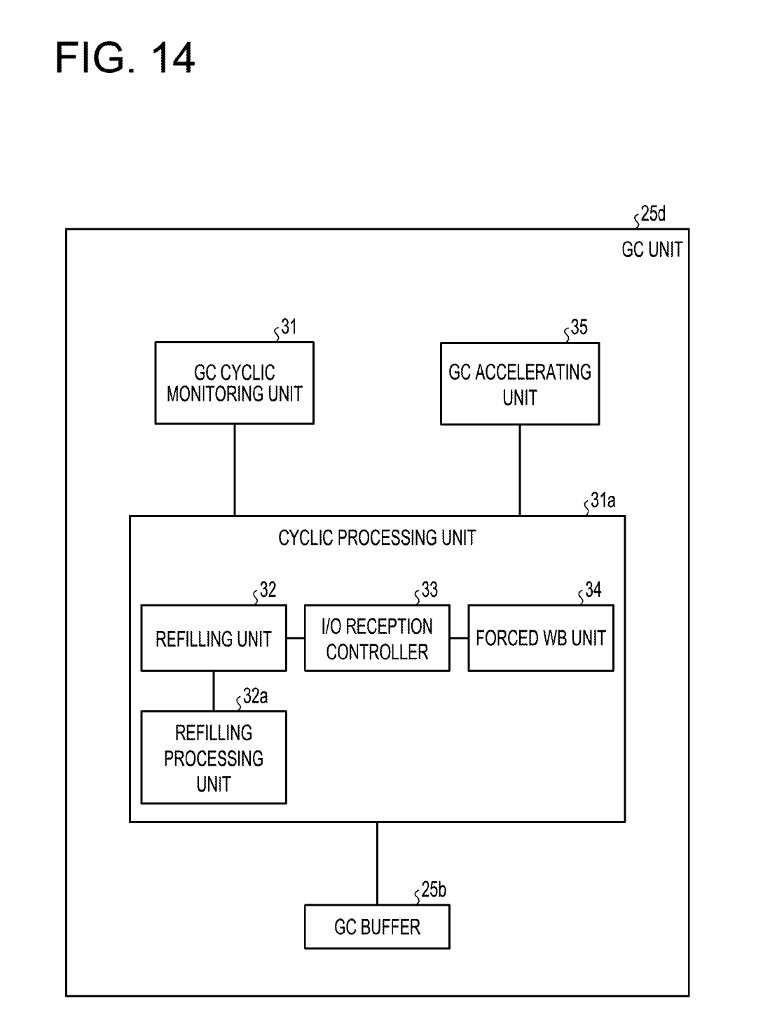

FIG. 14 is a view illustrating the functional configuration of the GC unit 25d. As illustrated in FIG. 14, the GC unit 25d includes a GC cyclic monitoring unit 31, a GC cyclic processing unit 31a, and a GC accelerating unit 35. The GC cyclic monitoring unit 31 controls the execution of the GC cyclic processing.

The GC cyclic processing unit 31a performs the GC cyclic processing. The GC cyclic processing unit 31a includes a refilling unit 32, a refilling processing unit 32a, an I/O reception controller 33, and a forced WB unit 34.

The refilling unit 32 controls the execution of the refilling processing. The refilling processing unit 32a performs the refilling processing. The I/O reception controller 33 sets the refilled GC buffer 25b to the I/O receivable state. The forced WB unit 34 forcibly writes the GC buffer 25b in the storage 3 when the GC buffer 25b is not filled within a predetermined time.

The GC accelerating unit 35 accelerates the GC processing by performing delay control and multiplicity control based on the pool remaining capacity. Here, the delay control indicates control of delaying the I/O to the pool 3a with the reduced remaining capacity. The multiplicity control indicates control of the multiplicity of the refilling processing and control of the number of CPU cores used for the GC.

The GC accelerating unit 35 requests the duplication management unit 23 to delay the I/O to the pool 3a with the reduced remaining capacity, and the duplication management unit 23 determines the delay time and requests the upper-level connection unit 21 for the delay together with the delay time. In addition, the GC accelerating unit 35 requests the core controller 27 to control the multiplicity and the number of CPU cores based on the pool remaining capacity.

For example, when the pool remaining capacity is 21% to 100%, the core controller 27 determines the multiplicity and the number of CPU cores as 4-multiplex and 2-CPU core, respectively. When the pool remaining capacity is 11% to 20%, the core controller 27 determines the multiplicity and the number of CPU cores as 8-multiplex and 4-CPU core, respectively. When the pool remaining capacity is 6% to 10%, the core controller 27 determines the multiplicity and the number of CPU cores as 12-multiplex and 6-CPU core, respectively. When the pool remaining capacity is 0% to 5%, the core controller 27 determines the multiplicity and the number of CPU cores as 16-multiplex and 8-CPU core, respectively.

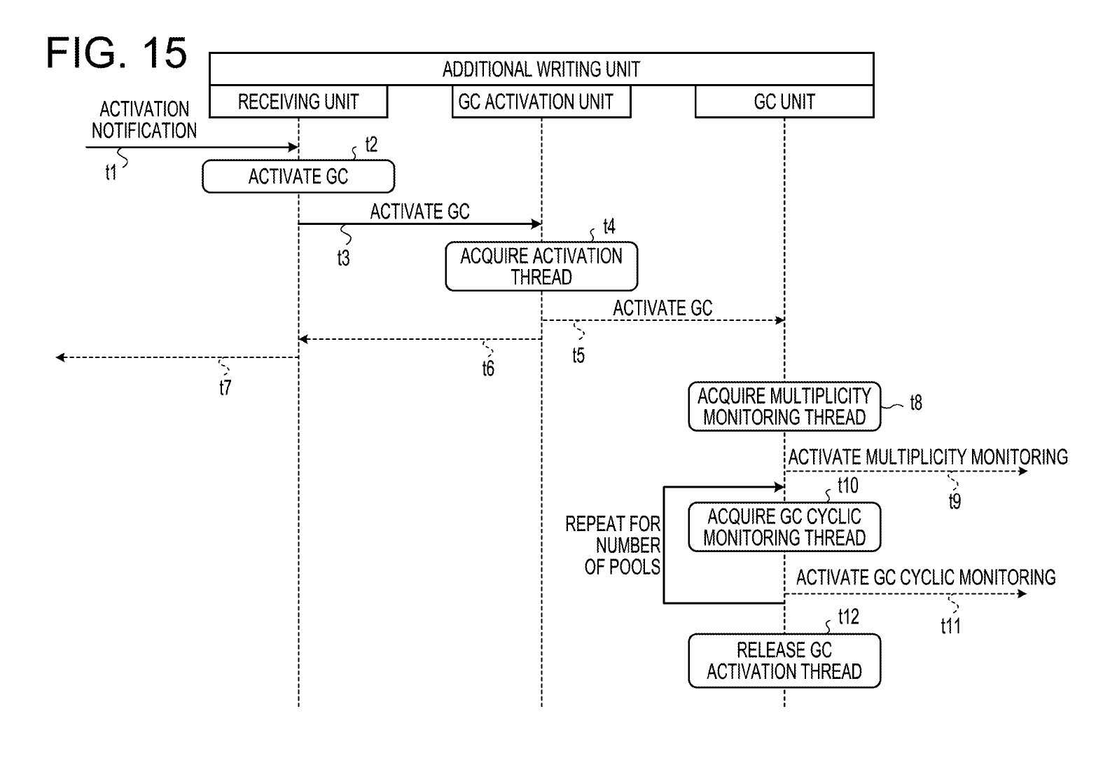

Next, a flow of the GC operation will be described. FIG. 15 is a view illustrating a sequence of GC activation. As illustrated in FIG. 15, a receiving unit of the additional writing unit 25 receives an activation notification for requesting the activation of the GC from a system manager that controls the entire storage device 1a (t1) and activates the GC (t2). That is, the receiving unit requests a GC activation unit to activate the GC (t3).

Then, the GC activation unit acquires a thread for GC activation (t4) and activates the acquired GC activation thread (t5). The activated GC activation thread operates as the GC unit 25d. Then, the GC activation unit responds to the receiving unit with the GC activation (t6), and the receiving unit responds to the system manager with the GC activation (t7).

The GC unit 25d acquires a thread for multiplicity monitoring (t8), and activates the multiplicity monitoring by activating the acquired multiplicity monitoring thread (t9). Then, the GC unit 25d acquires a thread for GC cyclic monitoring (t10), and activates the GC cyclic monitoring by activating the acquired GC cyclic monitoring thread (t11). The GC unit 25d performs the processes of t10 and t11 as many as the number of pools 3a. Then, when the GC cyclic monitoring is completed, the GC unit 25d releases the GC activation thread (t12).

In this manner, the GC unit 25d may perform the GC by activating the GC cyclic monitoring.

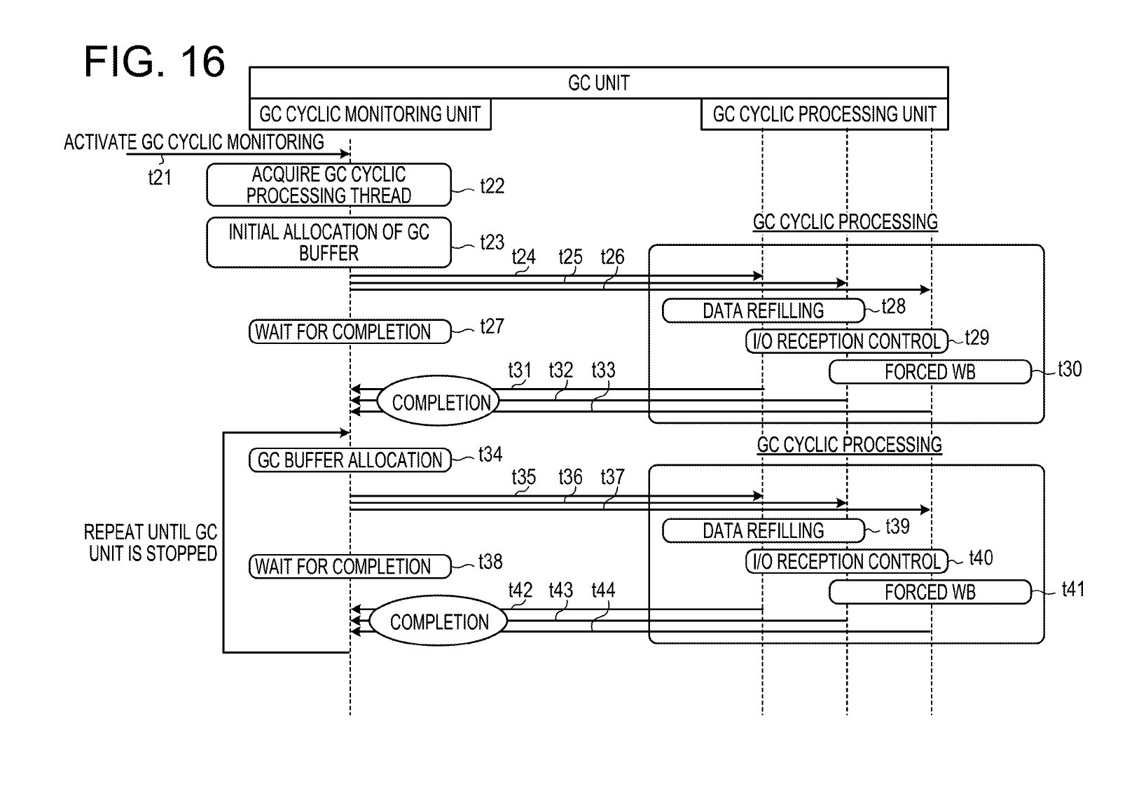

FIG. 16 is a view illustrating a sequence of GC cyclic monitoring. In FIG. 16, the GC cyclic monitoring unit 31 is a thread for GC cyclic monitoring. As illustrated in FIG. 16, when the GC cyclic monitoring is activated by the GC unit 25d (t21), the GC cyclic monitoring unit 31 acquires a thread for GC cyclic processing (t22). The GC cyclic processing unit 31a is a thread for GC cyclic processing. The GC cyclic processing thread includes three threads: a data refilling thread, an I/O reception control thread and a forced WB (write back) thread.

Then, the GC cyclic monitoring unit 31 performs initial allocation of the GC buffer 25b (t23), activates the data refilling thread, the I/O reception control thread, and the forced WB thread (t24 to t26), and waits for completion (t27). Then, the data refilling thread performs data refilling (t28). In addition, the I/O reception control thread performs I/O reception control (t29). In addition, the forced WB thread performs forced WB (t30). Then, when the GC processing is completed, the data refilling thread, the I/O reception control thread, and the forced WB thread respond to the GC cyclic monitoring unit 31 with the completion (t31 to t33).

Then, the GC cyclic monitoring unit 31 performs allocation of the GC buffer 25b (t34), activates the data refilling thread, the I/O reception control thread, and the forced WB thread (t35 to t37), and waits for completion (t38). Then, the data refilling thread performs data refilling (t39). In addition, the I/O reception control thread performs I/O reception control (t40). In addition, the forced WB thread performs forced WB (t41).

Then, when the GC processing is completed, the data refilling thread, the I/O reception control thread, and the forced WB thread respond to the GC cyclic monitoring unit 31 with the completion (t42 to t44). Then, the GC cyclic monitoring unit 31 repeats the processing from t34 to t44 until the GC unit 25d stops.

In this manner, the GC unit 25d repeats the GC cyclic processing so that the storage control device 2 may perform GC on the storage 3.

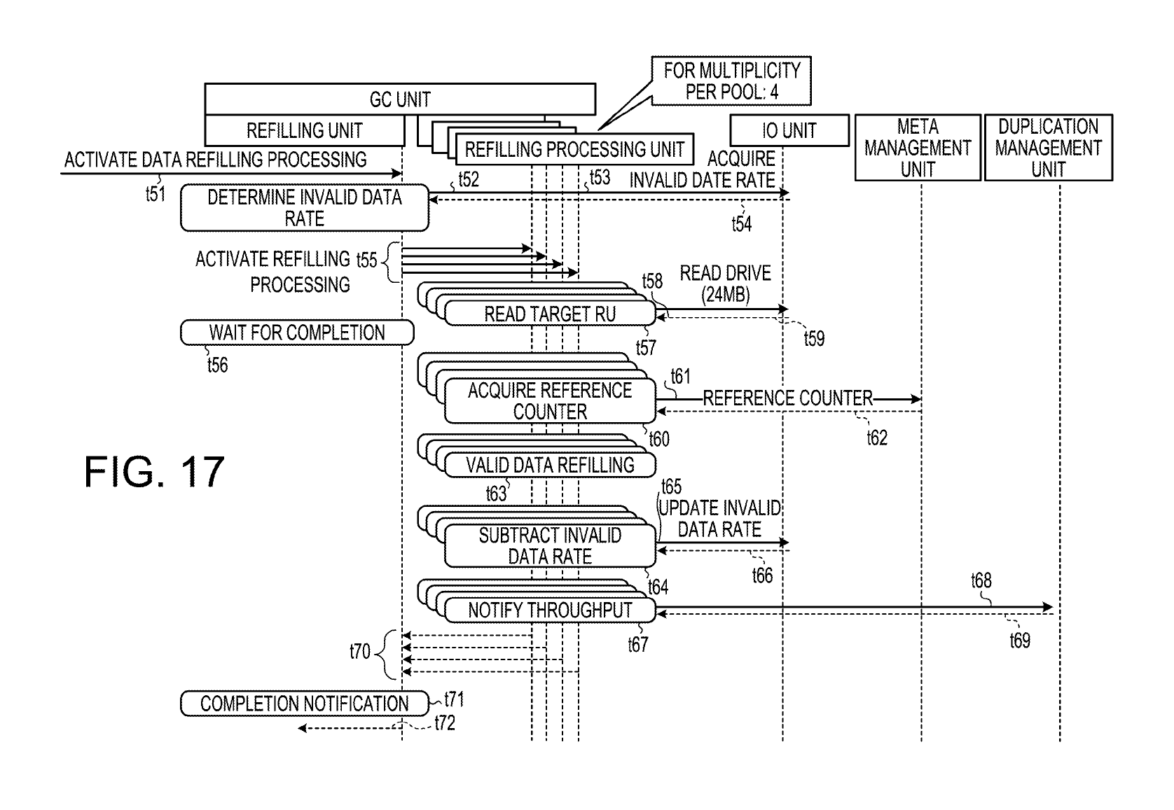

Next, a sequence of the data refilling processing will be described. FIG. 17 is a view illustrating a sequence of data refilling processing. In FIG. 17, the refilling unit 32 is a data refilling thread, and the refilling processing unit 32a is a refilling processing thread which is quadrupled per pool 3a.

As illustrated in FIG. 17, when the data refilling processing is activated by the GC cyclic monitoring unit 31 (t51), the refilling unit 32 determines an invalid data rate (t52). That is, the refilling unit 32 acquires an invalid data rate from the IO unit 26 (t53 to t54) and makes a determination on the acquired invalid data rate.

Then, the refilling unit 32 activates the refilling processing by activating the refilling processing thread with a RU with an invalid data rate equal to or larger than a threshold value based on the remaining capacity of the pool 3a, as a target RU (t55), and waits for completion (t56). Here, four refilling processing threads are activated.

The refilling processing unit 32a reads the target RU (t57). That is, the refilling processing unit 32a requests the IO unit 26 for drive read (t58) and reads the target RU by receiving a response from the IO unit 26 (t59). Then, the refilling processing unit 32a acquires a reference counter corresponding to each data unit in the data block (t60). That is, the refilling processing unit 32a requests the meta management unit 24 to transmit a reference counter (t61) and acquires the reference counter by receiving a response from the meta management unit 24 (t62).

Then, the refilling processing unit 32a specifies valid data based on the reference counter and performs valid data refilling (t63). Then, the refilling processing unit 32a subtracts the invalid data rate (t64). That is, the refilling processing unit 32a requests the IO unit 26 to update the invalid data rate (t65) and subtracts the invalid data rate by receiving a response from the IO unit 26 (t66).

Then, the refill processing unit 32a notifies a throughput (t67). Specifically, the refilling processing unit 32a notifies, for example, the remaining capacity of the pool 3a to the duplication management unit 23 (t68) and receives a response from the duplication management unit 23 (t69). Then, the refilling processing unit 32a responds to the refilling unit 32 with the completion of the refilling (t70), and the refilling unit 32 notifies the completion of the data refilling to the GC cyclic monitoring unit 31 (t71). That is, the refilling unit 32 responds to the GC cyclic monitoring unit 31 with the completion (t72).

In this manner, the refilling processing unit 32a may secure a free area in the data block by specifying valid data based on the reference counter and refilling the specified valid data.

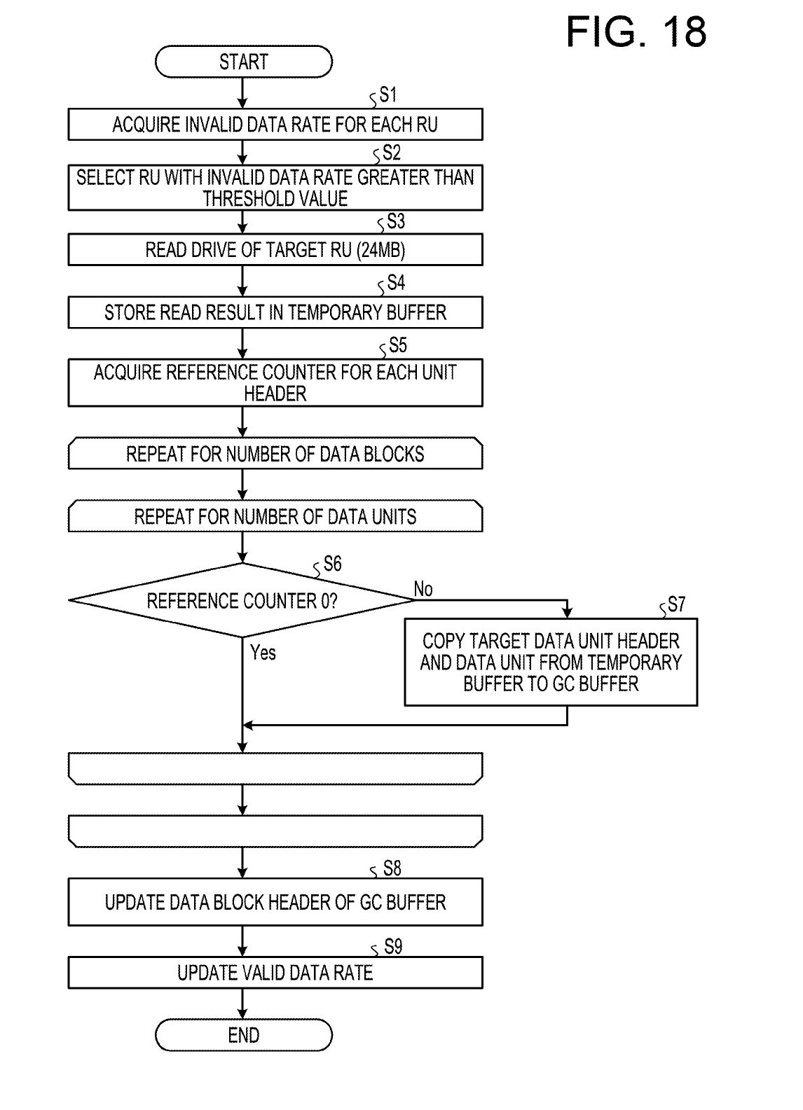

FIG. 18 is a flowchart illustrating a flow of the data refilling processing. As illustrated in FIG. 18, the GC cyclic processing unit 31a requests the IO unit 26 to acquire an invalid data rate for each RU (step S1), and selects an RU with an invalid data rate greater than a threshold value (step S2). Then, the GC cyclic processing unit 31a reads a drive of a target RU (step S3). Processing is performed in parallel for each RU in accordance with the multiplicity from the processing in step S3.

Then, the GC cyclic processing unit 31a stores the read result in a temporary buffer (step S4) and requests the meta management unit 24 to acquire a reference counter for each data unit header (step S5). Then, the GC unit 25d determines whether or not the reference counter is 0 (step S6). When it is determined that the reference counter is not 0, the GC unit 25d repeats a process of copying the target data unit header and data unit from the temporary buffer to the GC buffer 25b (step S7). The GC cyclic processing unit 31a repeats the processing of steps S6 and S7 for the number of data units of one data block by the number of data blocks.

In addition, when copying to the GC buffer 25b, the GC cyclic processing unit 31a performs front-filling of a data unit in the payload area and copies a data unit header to the same location. However, the Offset Block Count of the data unit header is recalculated based on the position to which the data unit is moved by the front-filling.

Then, the GC cyclic processing unit 31a updates the data block header of the GC buffer 25b (step S8). Upon updating, the GC unit 25d recalculates data blocks other than Data Block No. in the data block header from the refilled data. Then, the GC cyclic processing unit 31a requests the IO unit 26 to update the number of valid data (step S9). Here, the number of valid data is TDLC and GDLC.

In this manner, the GC cyclic processing unit 31a specifies the valid data based on the reference counter and copies the data unit header and data unit of the specified valid data from the temporary buffer to the GC buffer 25b, so that a free area may be secured in the data block.

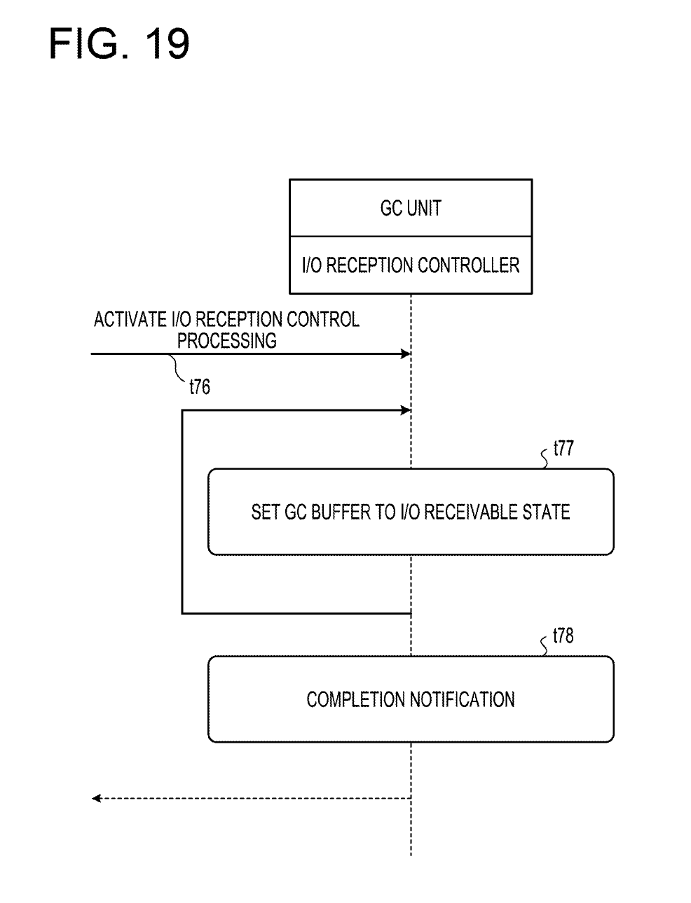

Next, a sequence of the I/O reception control processing will be described. FIG. 19 is a view illustrating a sequence of the I/O reception control processing. In FIG. 19, the I/O reception controller 33 is an I/O reception control thread.

As illustrated in FIG. 19, the I/O reception control processing by the GC cyclic monitoring unit 31 is activated (t76). Then, the I/O reception controller 33 sets the GC buffer 25b which has been subjected to the refilling processing, to a state in which the I/O reception may be prioritized over the write buffer 25a (t77). The processing of t77 is repeated by the number of GC buffers 25b for which the data refilling has been completed. Further, when the GC buffer 25b set to be in the I/O receivable state is filled up, the GC buffer 25b is written in the storage 3 by group writing. Then, the I/O reception controller 33 notifies the completion of the I/O reception control to the GC cyclic monitoring unit 31 (t78).

In this manner, the I/O reception controller unit 33 sets the GC buffer 25b to a state in which the I/O reception may be prioritized over the write buffer 25a, thereby making it possible to additionally write data in a free area in the data block.

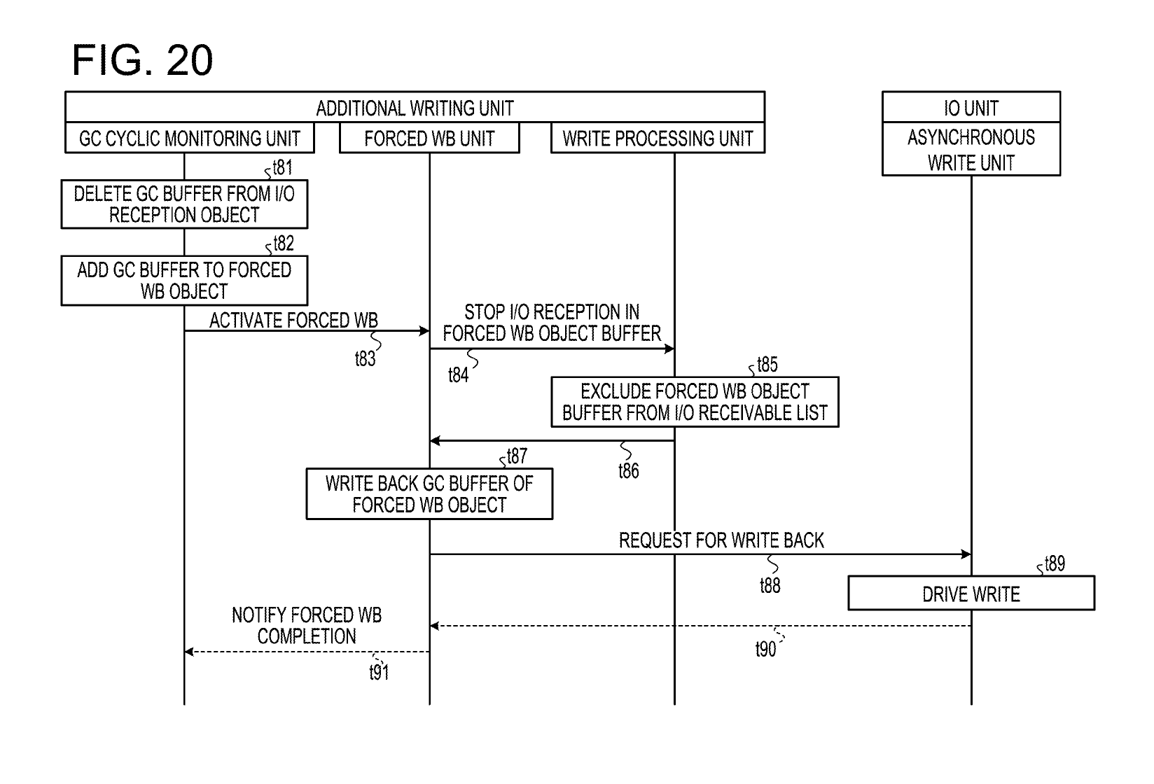

Next, a sequence of the forced WB processing will be described. FIG. 20 is a view illustrating a sequence of the forced WB processing. In FIG. 20, the forced WB unit 34 is a forced WB thread. As illustrated in FIG. 20, the GC cyclic monitoring unit 31 deletes the GC buffer 25b from the I/O reception target (t81) and adds the GC buffer 25b to the forced WB target (t82). Then, the GC cyclic monitoring unit 31 activates the forced WB (t83).

Then, the forced WB unit 34 requests the write processing unit 25c to stop the I/O reception in the forced WB target buffer (t84). Then, the write processing unit 25c excludes the forced WB target buffer from an I/O receivable list (t85) and responds to the forced WB unit 34 with the completion of the I/O reception stop (t86).

Then, the forced WB unit 34 writes back the GC buffer 25b of the forced WB target (t87). That is, the forced WB unit 34 requests the IO unit 26 to write back the GC buffer 25b of the forced WB target (t88), and an asynchronous write unit of the IO unit 26 performs drive write of the GC buffer 25b of the forced WB target (t89).

Then, the forced WB unit 34 receives a completion notification from the asynchronous write unit (t90). The processing from t87 to t90 is performed by the number of GC buffers 25b of the forced WB target. Then, the forced WB unit 34 responds to the GC cyclic monitoring unit 31 with the forced WB completion notification (t91).

In this manner, the forced WB unit 34 may request the asynchronous write unit to write back the GC buffer 25b of the forced WB target, so that the GC cyclic processing may be completed even when the I/O is small.

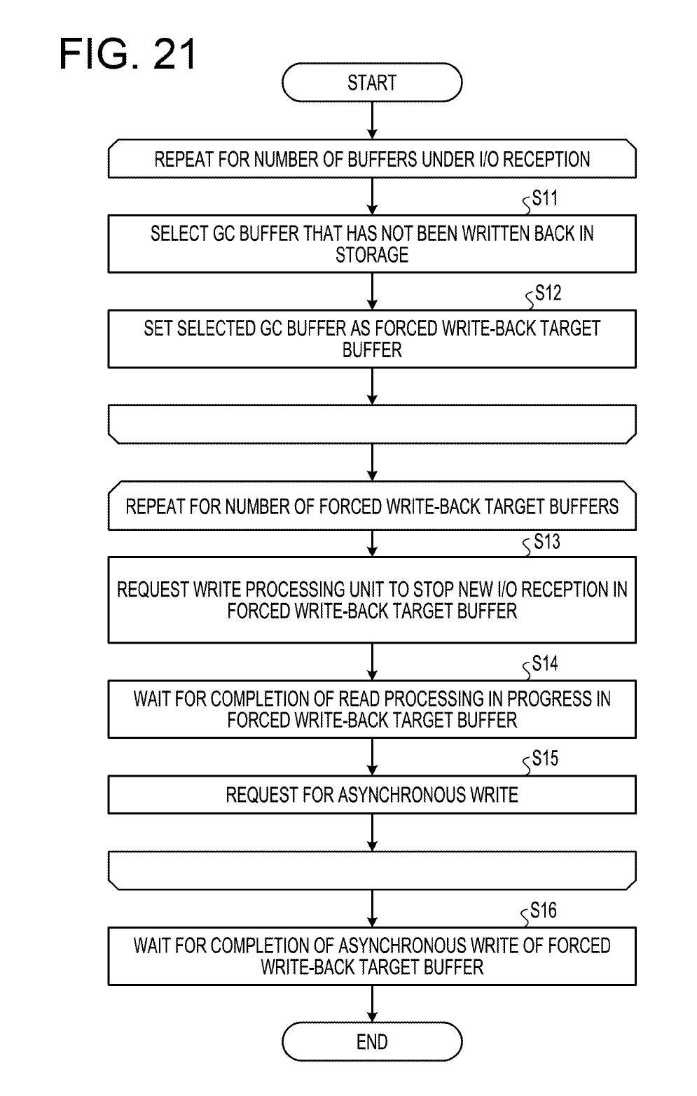

Next, a flow of the forced WB processing will be described. FIG. 21 is a flowchart illustrating a flow of the forced WB processing. As illustrated in FIG. 21, the GC unit 25d repeats the following steps S11 and S12 by the number of GC buffers 25b under I/O reception. The GC unit 25d selects a GC buffer 25b that has not been written back in the storage 3 (step S11), and sets the selected GC buffer 25b as a forced write-back target buffer (step S12).

Then, the GC unit 25d repeats the following steps S13 to S15 by the number of forced write-back target buffers. The GC unit 25d requests the write processing unit 25c to stop new I/O reception in the forced write-back target buffer (step S13), and waits for completion of the read processing in progress in the forced write-back target buffer (step S14). Then, the GC unit 25d requests the IO unit 26 for asynchronous write (step S15).

Then, the GC unit 25d waits for completion of the asynchronous write of the forced write-back target buffer (step S16).

In this manner, the forced WB unit 34 requests the IO unit 26 for asynchronous write of the forced write-back target buffer, so that the GC cyclic processing may be completed even when the I/O is small.

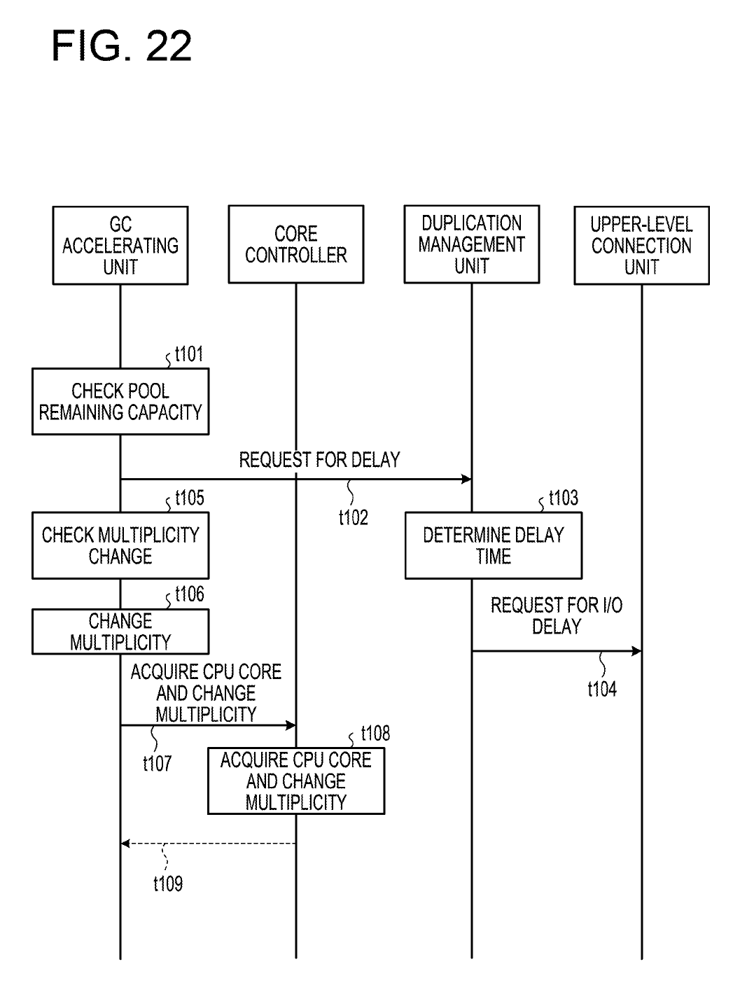

Next, a sequence of processing for delay control and multiplicity change will be described. FIG. 22 is a view illustrating a sequence of processing for delay control and multiplicity change. As illustrated in FIG. 22, the GC accelerating unit 35 checks the pool remaining capacity (t101). Then, the GC accelerating unit 35 determines a delay level based on the pool remaining capacity, and requests the duplication management unit 23 for delay of the determined delay level (t102). Then, the duplication management unit 2 determines a delay time according to the delay level (t103), and makes an I/O delay request to the upper-level connection unit 21 together with the delay time (t104).

In addition, the GC accelerating unit 35 checks whether to change the multiplicity based on the pool remaining capacity (t105). When it is determined that it is necessary to change the multiplicity, the GC accelerating unit 35 changes the multiplicity (t106). That is, when it is necessary to change the multiplicity, the GC accelerating unit 35 requests the core controller 27 to acquire the CPU core and change the multiplicity (t107).

Then, the core controller 27 acquires the CPU core and changes the multiplicity based on the pool remaining capacity (t108). Then, the core controller 27 responds to the GC accelerating unit 35 with the completion of the multiplicity change (t109).

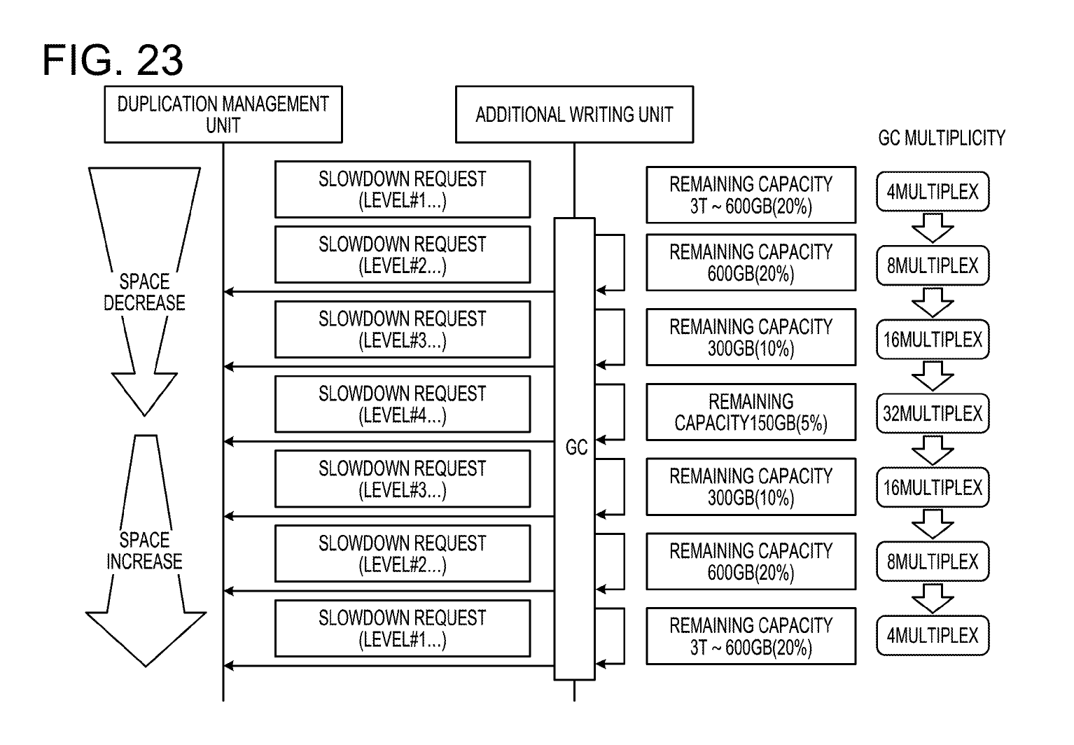

FIG. 23 is a view illustrating an example of delay control and multiplicity change. As illustrated in FIG. 23, for example, when the pool remaining capacity changes from a state exceeding 20% to a state of 20% or less, the GC accelerating unit 35 sends a slowdown request of level#2 to the duplication management unit 23 to request the core controller 27 to change the multiplicity. The core controller 27 changes the multiplicity from 4-multiplex to 8-multiplex. Further, for example, when the pool remaining capacity changes from a state of 5% or less to a state exceeding 5%, the GC accelerating unit 35 sends a slowdown request of level#3 to the duplication management unit 23 to request the core controller 27 to change the multiplicity. The core controller 27 changes the multiplicity from 32-multiplex to 16-multiplex.

In this manner, since the GC accelerating unit 35 performs the I/O delay control and the multiplicity change control based on the pool remaining capacity, it is possible to optimize the balance between the pool remaining capacity and the performance of the storage device 1a.

As described above, in the embodiment, the refilling processing unit 32a reads out the GU target RU from the storage 3, stores the GC target RU in the GC buffer 25b, and performs front-filling of the valid data unit in the payload area for each data block included in the GC buffer 25b. In addition, the refilling processing unit 32a updates the offset of the data unit header corresponding to the data unit moved by the front-filling. In addition, the refilling processing unit 32a does not refill an index. Therefore, it is unnecessary to update the logical-physical meta in the GC, thereby reducing the amount of writing in the GC.

In addition, in the embodiment, since the I/O reception controller 33 sets the refilled GC buffer 25b to a state in which the I/O reception is preferentially performed, an area collected by the GC may be used effectively.

In addition, in the embodiment, when the GC buffer 25b set to the state in which the I/O reception is preferentially performed is not written back in the storage 3 even after elapse of a predetermined time, since the forced WB unit 34 compulsorily writes back the GC buffer 25b, the stagnation of the GC cyclic processing may be prevented.

In addition, in the embodiment, since the refilling unit 32 changes a threshold value based on the pool remaining capacity with a RAID unit having an invalid data rate equal to or greater than a predetermined threshold value as the GC target, it is possible optimize the balance between secure of much free capacity and efficient GC.

In addition, in the embodiment, since the I/O delay control and the multiplicity change control are performed based on the pool remaining capacity, it is possible to optimize the balance between the pool remaining capacity and the performance of the storage device 1a.

Further, although the storage control device 2 has been described in the embodiments, a storage control program having the same function may be obtained by implementing the configuration of the storage control device 2 with software. A hardware configuration of the storage control device 2 that executes the storage control program will be described below.

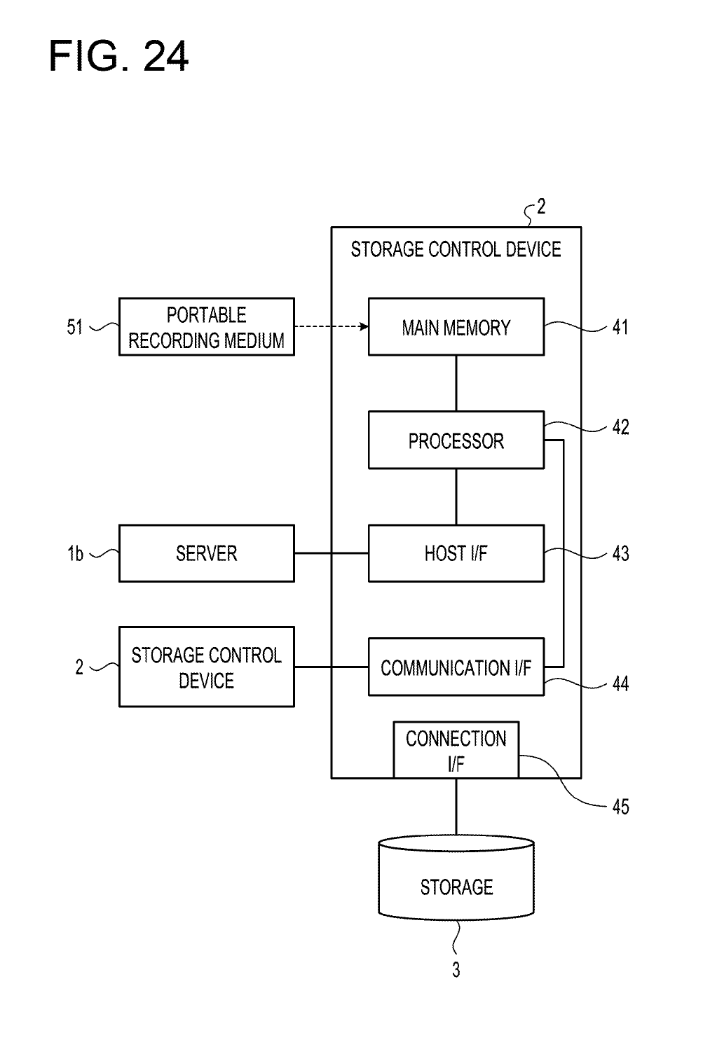

FIG. 24 is a view illustrating a hardware configuration of the storage control device 2 that executes the storage control program according to an embodiment. As illustrated in FIG. 24, the storage control device 2 includes a main memory 41, a processor 42, a host I/F 43, a communication I/F 44, and a connection I/F 45.

The main memory 41 is a RAM (Random Access Memory) that stores, for example, programs and intermediate results of execution of the programs. The processor 42 is a processing device that reads out and executes a program from the main memory 41.

The host I/F 43 is an interface with the server lb. The communication I/F 44 is an interface for communicating with another storage control device 2. The connection I/F 45 is an interface with the storage 3.

The storage control program executed in the processor 42 is stored in a portable recording medium 51 and is read into the main memory 41. Alternatively, the storage control program is stored in, for example, a database or the like of a computer system coupled via the communication I/F 44 and is read from the database into the main memory 41.

Further, a case where the SSD 3d is used as a nonvolatile storage medium has been described in the embodiment. However, the present disclosure is not limited thereto but may be equally applied to other nonvolatile storage medium having a limit on the number of times of writing as in the SSD 3d.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control device for controlling a storage that employs a storage medium that has a limit in a number of times of writing, the storage control device comprising:
a memory configured to provide a first buffer area for storing a group write area in which a plurality of data blocks are arranged, wherein the group write area is a target of garbage collection to be performed by the storage control device, each of the plurality of data blocks includes a header area and a payload area, the header area stores a header at a position indicated by index information corresponding to a data unit stored in the data block, the header includes an offset and a length of the data unit, and the payload area stores the data unit at a position indicated by the offset; and
a processor coupled to the memory and the processor configured to:
read out a first group write area from the storage medium;
store the first group write area in the first buffer area;
release a part of the payload area for each data block arranged in the first group write area stored in the first buffer area, wherein the part stores invalid data; and
perform the garbage collection by performing data refilling, wherein the data refilling is performed by:
moving valid data stored in the payload to fill up a front by using the released part; and
updating an offset included in a header stored in the header area at a position indicated by index information corresponding to the moved valid data without changing the position indicated by the index information corresponding to the moved valid data.

2. The storage control device according to claim 1, wherein
the memory is further configured to provide a second buffer area for storing data to be written to the storage medium by an information processing apparatus that uses the storage, the data to be written is allocated to each data block, and
the processor is further configured to:
perform a write operation to the storage medium by using the second buffer region; and
set the first buffer area as the second buffer area to be preferentially used after the data refilling is performed for all the data blocks in the first buffer area.

3. The storage control device according to claim 2, wherein the processor is further configured to:
forcibly write data stored in the first buffer area to the storage medium
when the data stored in the first buffer area is not written to the storage medium even after a predetermined time has elapsed after setting the first buffer area as the second buffer area to be preferentially used.

4. The storage control device according to claim 1, wherein
the processor is further configured to:
perform control of reading out a second group write area that has an invalid data rate equal to or greater than a predetermined threshold value from the storage medium and storing the second group write area in the first buffer region; and
perform control of changing the predetermined threshold value based on a remaining capacity of the storage medium.

5. The storage control device according to claim 1, wherein
the processor is further configured to:
control a delay of input/output processing of the storage based on a remaining capacity of the storage;
control a multiplicity that indicates a number of parallel execution of the garbage collection; and
control a number of central processing unit (CPU) cores used for the garbage collection based on the remaining capacity of the storage.

6. A storage control method for controlling a storage that employs a storage medium that has a limit in a number of times of writing, wherein the storage medium stores a group write area in which a plurality of data blocks are arranged, each of the plurality of data blocks includes a header area and a payload area, the header area stores a header at a position indicated by index information corresponding to a data unit stored in the data block, the header includes an offset and a length of the data unit, and the payload area stores the data unit at a position indicated by the offset, the storage control method comprising:
reading out, by a computer, a first group write area from the storage medium;
storing, as a target of garbage collection to be performed by the computer, the first group write area in a first buffer area; and
releasing a part of the payload area for each data block arranged in the first group write area stored in the first buffer area, wherein the part stores invalid data; and
performing the garbage collection by performing data refilling, wherein the data refilling is performed by:
moving valid data stored in the payload to fill up a front by using the released part; and
updating an offset included in a header stored in the header area at a position indicated by index information corresponding to the moved valid data without changing the position indicated by the index information corresponding to the moved valid data.

7. The storage control method according to claim 6, further comprising:
storing, in a second buffer area, data to be written to the storage medium by an information processing apparatus that uses the storage, by allocating the data to be written to each data block; and
setting, after the data refilling is performed for all the data blocks in the first buffer area, the first buffer area as the second buffer area to be preferentially used in writing data to the storage medium.

8. The storage control method according to claim 7, further comprising:
forcibly writing data stored in the first buffer area to the storage medium when the data stored in the first buffer area is not written to the storage medium even after a predetermined time has elapsed after setting the first buffer area as the second buffer area to be preferentially used in writing data to the storage medium.

9. A non-transitory computer-readable recording medium having stored therein a program that causes a computer to execute a process, wherein the computer controls a storage that employs a storage medium that has a limit in a number of times of writing, the storage medium stores a group write area in which a plurality of data blocks are arranged, each of the plurality of data blocks includes a header area and a payload area, the header area stores a header at a position indicated by index information corresponding to a data unit stored in the data block, the header includes an offset and a length of the data unit, and the payload area stores the data unit at a position indicated by the offset, the process comprising:
reading out a first group write area from the storage medium;
storing, as a target of garbage collection to be performed by the computer, the first group write area in a first buffer area; and
releasing a part of the payload area for each data block arranged in the first group write area stored in the first buffer area, wherein the part stores invalid data; and
performing the garbage collection by performing data refilling, wherein the data refilling is performed by:
moving valid data stored in the payload to fill up a front by using the released part; and
updating an offset included in a header stored in the header area at a position indicated by index information corresponding to the moved valid data without changing the position indicated by the index information corresponding to the moved valid data.

10. The non-transitory computer-readable recording medium according to claim 9, the process further comprising:
storing, in a second buffer area, data to be written to the storage medium by an information processing apparatus that uses the storage, by allocating the data to be written to each data block; and
setting, after the data refilling is performed for all the data blocks in the first buffer area, the first buffer area as the second buffer area to be preferentially used in writing data to the storage medium.

11. The non-transitory computer-readable recording medium according to claim 10, the process further comprising:
forcibly writing data stored in the first buffer area to the storage medium when the data stored in the first buffer area is not written to the storage medium even after a predetermined time has elapsed after setting the first buffer area as the second buffer area to be preferentially used in writing data to the storage medium.
